(19) United States
(12) Patent Application Publication
(10) Pub. No.: US 2025/0305293 A1
(43) Pub. Date: Oct. 2, 2025

(54) WALL CLADDING KITS, SYSTEMS, METHODS AND STRUCTURES FORMED THEREWITH

(71) Applicant: TIDHAR ECO WALL LTD, Ramat HaSharon (IL)

(72) Inventors: Moshe LAMDAN, Kadima Tzoran (IL); Ariel POKOTINSKY, Ramat HaSharon (IL)

(73) Assignee: TIDHAR ECO WALL LTD, Ramat HaSharon (IL)

(21) Appl. No.: 19/106,675

(22) PCT Filed: May 17, 2022
(86) PCT No.: PCT/IL2022/050513

§ 371 Date: Feb. 26, 2025

(51) Int. Cl. E04F 13/08; F16B 13/12

(52) U.S. Cl. CPC E04F 13/0835; E04F 13/0851; F16B 13/124

(57) ABSTRACT

Wet cladding methods are disclosed which allow for construction and concomitant cladding of back-up walls. The end-cladding elements are attached to the wall using undercut anchors which are inserted into holes on the back surface of the end-cladding elements.

### RELATED APPLICATION/S

The instant application claim priority under the Paris Convention from Israel Application No. 288213, filed 17 Nov. 2021, the contents of which is hereby incorporated by reference in its entirety.

### FIELD AND BACKGROUND OF THE INVENTION

The present invention, in some embodiments thereof, relates to wall cladding kits, systems, methods and structures cladded therewith and, more particularly, but not exclusively, to wet wall cladding kits, systems, methods and structures cladded therewith.

Wall cladding is often used in place of plastering to provide an aesthetic and durable finish to both interior and exterior walls. The finish may be decorative as well as functional. There are different wall cladding systems and methods. Gluing is the simplest and cheapest method, and is often used for internal walls. In this method an end cladding element or material (as these terms are used alternatively throughout), e.g., a ceramic tile, is directly glued onto an existing (i.e., pre-existing, backup, all three terms are used herein interchangeable) wall. Building standards typically limit the use of gluing for external wall cladding at least to maximal height and/or weight or tile size, as gluing durability relies on the skill of the workman, material selection and aging and is therefore difficult to ensure.

Dry wall cladding is a system used primarily on external walls. In dry wall cladding, the end cladding material is mechanically fixed directly or indirectly to a (pre-existing) wall with steel attachments, e.g., screws, that restrain its vertical and horizontal movement. The steel attachments may be fixed directly into the wall, or may be fixed onto galvanized or stainless metal beams positioned along and connected to the pre-existing wall. Various types of attachments are available. In one known method, an attachment in the form of an undercut anchor which is secured to the back surface (i.e., underside) of the end cladding material is used. This method is based on drilling an undercut hole into the back surface of the end cladding material and fixing the undercut anchor onto the end cladding material with a simple screw aimed at flaring the undercut anchor. Typically, the end cladding material is fixed to the wall with an air gap formed by the beams. The air gap may provide ventilation as assisting in thermal insulation of the cladded structure. Although dry wall cladding is known to be highly durable, it is also costly and requires skilled labor as compared to the gluing method and/or wet cladding methods as is further delineated herein below. Because of the large potential number of locations in the back surface of the end cladding element, in dry cladding there is no size limitation imposed by the method per se to the size of the end cladding element. This allows for architectural and functional variations as required and/or desired. Hence, dry cladding allows the architectural selection of numerous end cladding materials, such as, but not limited to, ceramics, stone, artificial stone, architectural concrete, HPL and various forms of aluminum in any size, shape, color, texture, shin or finish.

Wet cladding is another method for external wall cladding that is often used in Israel, as well as other regions in the middle-east to clad external walls with natural stone and/or artificial stone made of concrete (for the latter, see section 1872 Part 1 of the Israeli building standard). About 80% of the residential buildings in Israel are cladded using wet cladding methodologies. Wet cladding involves embedding mechanical fixing elements into an end cladding element at one end and to a wet cementitious material at the other end. Typically, but not necessarily, wet cladding combines gluing, i.e., chemical bonding, as well as mechanical fixing as is further discussed herein under.

For both regulatory and practical reasons, all three wet cladding methods practiced in Israel are limited to stone.

One method of wet cladding which is limited to stone having 2-3 cm thickness, is detailed in section 2378 Part 2 of the Israeli building standard and is typically used when cladding with Jerusalem stone. Section 2378 Part 2 requires fixing a reinforcement metal mesh to a backup wall, gluing a row of stones over the reinforcement metal mesh with mortar while mechanically fixing the stones to the reinforcement metal mesh and the mortar (once hardened) with metal pins having a predefined structure. Each such metal pin has a proximal section, a middle section and a distal section. The proximal section of the pin is designed to be inserted into a pre-drilled hole extending along the thickness, i.e., the edge surface, the upper, left and right side, of the stone, which is why the stone has to be at least 2 cm thick. This is true for all wet cladding methods practiced. The distal section is designed to protrude from the edge surface of the stone towards the net and backup wall. Section 2378 Part 2 further requires forming a slot extending from the hole to the back surface of the end cladding material, so as to embrace the middle section of the pin, in order to ensure the pin will not fall off the stone during construction. The metal pins provide for mechanical fixing to secure the stones to the backup wall in addition to gluing, i.e., chemically bonding, with the mortar, resulting in higher durability and safety of the cladded structure. As discussed, in Section 2378 Part 2, the end cladding material is required to be stone having a thickness of at least 2 cm. The metal pins are required to have a diameter of 3.5 mm. The 2 cm thickness supports drilling holes and slots through a thickness (i.e., side) of the stone and accommodates inserting the metal pins with a diameter of 3.5 mm therein. This particular cladding method requires assembling a scaffold for constructing a backup wall, disassembling the scaffold and allowing the backup wall to harden, re-assembling the scaffold for cladding and re-disassembling the scaffold after cladding. Thus, scaffolds are assembled and disassembled twice. This process is labor intensive, far from being “industrial”, not at all economical and/or regulatory viable and not at all practical for buildings higher than 9 stories.

The Baranovich method (named after Eng. Mr. Baranovich, who invented the method) is yet another known wet cladding method that has been commonly used in Israel since the 1980's. The Baranovich method is designed to solve the limitations described above for wet cladding, rendering wet cladding more industrial, less labor-intensive, cheaper, faster to construct and practical for buildings of any height. In fact, nearly all residential building higher than 9 stories in Israel are built using the Baranovich method. The Baranovich method is solely practiced in Israel. Standardization of this method was established in 2015 in the Israeli Building standard 2378 Part 5. In the Baranovich method, the external wall of a structure is formed and concurrently cladded with a stone exterior. Being more industrialized, this method conserves construction time, is less prone to construction mistakes and increases the durability and homogeneity of the cladding. In the Baranovich method, rows of stones are laid against an outer formwork sheet and similar to the manual wet cladding method described above, metal pins are fitted through pre-drilled holes and slots. A reinforcement metal mesh is placed behind the stones with the pins extending in the direction of the reinforcement metal mesh, without a required physical engagement there between. The stones are held in place by tying the reinforcement metal mesh and the outer formwork sheet with a barbed wire which is inserted via holes formed in the outer formwork sheet, thereby securing the stones between the outer sheet and the reinforcement metal mesh. Rows of stones are spaced from one another via spacers formed on the back surface of the outer formwork sheet. The gaps between the stones are sealed with a cementitious material commonly referred to in the art as “chochla” and the back surface is covered with a sealant, e.g., a primer, to prevent soaking of cement into the volume of stone, thereby preventing irreversible staining of the front surface of the stone. At this stage, a plurality of the described assemblies are hoisted (i.e., lifted) with a crane to a floor under construction, the inner formwork sheets are put in place (with or without heat insulating building blocks placed between the inner formwork sheet and the reinforcement metal mesh) and tied to the respective outer formwork sheets via a plurality of securing bolts passing between the two sheets through dedicated holes, generating a continuous formwork circumferencing the floor under construction. Concrete is poured in the gap between the inner formwork sheets (or the heat insulating building blocks when used) and the end cladding stone rows, in which gap the reinforcement metal mesh is pre-positioned. Once the concrete hardens the ties, the securing bolts and both formwork sheets are removed. The reinforcement metal mesh together with the concrete forms the external wall of the structure and cladding can then be carried out in a single step, without the need for scaffolds altogether. Building standard 2378 Part 5 also requires stone having a thickness of at least 2 cm and pins having a diameter of 3.5 mm. In practice, this standard also applies to pre-cast cladded walls, the difference being that the walls are typically formed in a factory and thereafter brought to a construction site and hoisted to floors under construction. Pre-cast stone cladded walls can be formed horizontally as well, whereby stone with pins as herein described are placed horizontally with the pins extending upwardly. A reinforcement metal mesh is placed thereon and concrete is poured to form the cladded pre-cast wall. Similarly, pre-cast stone cladded walls can be formed horizontally by forming a fortified wall structure (having a reinforcement metal mesh buried therein) and prior to hardening of the concrete, placing thereon end cladding stones with pins as herein described, the pins extending downwardly into the concrete and are physically engaged thereby when the concrete hardens.

For traditional wet cladding method and the Baranovich method, the mechanical fixing requires inserting pins through pre-drilled holes formed in the thickness (sides) of the stones. The stone for this purpose is required to have a certain thickness to support the drill hole and the pins.

The Baranovich method has its specific limitations as well. One major limitation is the fact that liquid cement pours through the gaps formed between the stones in the regions of the pins and in locations where the “chochla” seal is compromised, as well as through the holes formed in the outer formwork sheet for insertion of the barbed wire, and more so through the bolt-dedicated holes, resulting in cementitious material accumulating between the front surface of the stones and the back surface of the front sheet, staining the façade of the cladded wall. Such stains have to be removed after the entire construction is completed using sanding disk and/or pressurized water (see, for example, FIG. 15). This cleaning process costs ca. 40% of the total cost of typical cladding.

Another limitation associated with the Baranovich method is the misplacement of the pins, which are loosely engaged by the drilled holes, resulting in weakening the mechanical fixing of the stone to the concrete wall. Due to potential misplacement of the pins, while constructing using the Baranovich methods, the use of concrete pumps and ultrasonic vibrators are forbidden, hampering the construction quality as a whole.

The cladding regulations and methods described herein are limited to stone, which is thick for reasons described above and is therefore heavy, requiring heavier fortification for the entire structure.

Also, stone has inherent limitations, as detailed below:

It has a very high water absorption, requiring the addition of heat insulation layers to the inner side of the external walls of the structure and resulting in high water ingress and accelerated ageing of the construction as a whole.

It ages non-homogenously, its aging behavior is variable and unpredictable, resulting in cladding failure.

It readily stains, e.g., by graffiti, as it soaks the stains.

It is costly for numerous reasons. First natural stone is inherently costly. Second, natural stone is heavy, resulting is high shipping costs.

The architectural variety of cladding material is very limited to the extent that all the facades of constructions built therewith in Israel look very similar. The color consistency of natural stone is very poor.

The regulation requires that the pins are to be spaced no more than 30 cm apart from one another, resulting in that all the buildings wet cladded with stone are made of 30 cm high stone stripes because, as described above, the mechanical fixing pins are engaging the stone through the thickness (side) thereof.

The chemical bonding between the back surface of the stone and the cementitious material is weak, due to the use of sealant or primer.

Last, but not least, the use of natural stone harms the environment, considered not “green” and therefore quarries are being discontinued worldwide.

Table 1 below summarizes some of the differences between stone and non-stone (e.g., porcelain) end cladding elements.

TABLE 1

| | 10 mm thick | 20 mm thick |
|---|---|---|
| Item | Porcelain Tile | Natural Stone |
| Thermal Conductivity | 3 times more | − |
| | insulating | |
| Water Sealed Façade | + | − |
| Bending Strength (MPa) | 38 | 17 |
| Breaking Strength | At least 2500 | 1600 |
| Scratch Resistance | + | − |
| Chemical Resistance | + | − |
| Doesn't Contain salable salts and | + | − |
| Minerals | | |
| Consistent strength and resistance | + | − |
| Low Expansion with temp change | + | − |
| Uniform Size and color | + | − |
| Wide architectural variety | + | − |
| Doesn't Requires Expensive cleaning | + | − |
| Does not Absorb water and concrete | + | − |

Patent number IL243159 describes a cladding method designed to assist in thermal insulation by forming an air gap and ventilation path for hot air through the gap. The gap is formed by spacing a thermal insulation layer from the end cladding elements via spacers and pouring concrete between the back side of the layer and a back sheet of a formwork. Heat insulation layers are formed from soft, air trapping, materials, otherwise they are dysfunctional as heat insulating elements.

The drawbacks of the cladding method described in IL243159 are numerous.

First, during pouring of concrete at 600 Kg per square meter (as is the case using conventional Baranovich formwork), the heat insulation layer, especially at the lower end of the formwork, albeit the spacers, is likely to collapse over the back surface of the cladding elements, thereby eliminating or constricting the air gap, resulting in compromised or no air ventilation.

Second, the holes formed in the heat insulation layer to allow pins to protrude from the back surface of the layer into the concrete will allow the wet concrete to spill into the gap, further eliminating or constricting the air gap, resulting in compromised or no ventilation.

Third, there is no chemical bonding between the back surface of the end cladding elements and the concrete, as is specifically required by section 2378 Part 2 of the Israeli building standard.

Fourth, in order for the air gap to function as a ventilation gap, air gaps should also be maintained between the end cladding elements, resulting is a structure that may age faster over time due to water ingress through the gaps between the end cladding elements.

Fifth, although heat insulation layers are typically supplemented with fire retardants, nearly no fire retardation technology can prevent the ignition and burning of the insulation layer when fed by more and more heated oxygen containing air rushing ever faster through the gaps venting out from the top of the cladded structure, which may result in complete burnout and destruction of the entire cladded structure.

Sixth, there is no existing heat insulation layer that can withstand exposure to the elements over time as in this case. Indeed, ventilated building facades do exist, but are never used alongside with heat insulation layers exposed to the elements.

Seventh, although structurally and practically advantageous, the Baranovich method does not allow the use of concrete pumps nor the use of sonication probes, as using same may displace the pins. The method described in IL243159, also does not allow the use of concrete pumps, nor the use of sonication probes, because the weight of the wet concrete and aggregates therein, especially when accelerated by the concrete pump or sonication probe is not dissipated by any means which may result in the disengagement of the pins from the pre-formed holes in the back side of the end cladding elements, especially if ceramic porcelain tiles are used, whereby the depth of the pre-formed undercut hole cannot extend beyond ca. 5 mm into the end cladding element.

Last, but not least, the cladding method described in IL243159 fails to comply with Israeli building standard 1555, section 4, that pertains to structures having external air ventilated facades. In fact, there is no standard or combination of standards that would allow constructing an external cladded wall using the method described in IL243159.

Additional background art includes JP2003328532; DE102007060956; and U.S. Pat. No. 5,083,407; as well as the Israeli standards for building coverings, including, e.g., standard 314—Ceramic tiles definitions and specifications; standard 1555 Part 1—flooring and cladding in porcelain and mosaic outdoor cladding; standard 1555 part 2—flooring and cladding in porcelain and mosaic indoor and closed; standard 1555 part 4—flooring and cladding in porcelain and mosaic dry cladding; standard 1872 part 1—Cladding in artificial stone—definitions; standard 1872 part 2—Cladding in artificial stone—wet cladding; standard 1872 Part 4—Cladding in artificial stone—Gluing with mechanical fixing; standard 1872 part 5.1—Cladding in artificial stone—Precast and mechanical fixing; standard 1872 part 5.2.—Cladding in artificial stone—Toothed units; standard 2378 part 1—Cladding in stone—general demands; standard 2378 part 2—cladding in stone—wet cladding; standard 2378 part 3—cladding in stone—dry cladding; standard 2378 part 4—cladding in stone—gluing with mechanical fixing; standard 2378 part 5—cladding in stone—precast and on site pre casting; standard 2378 part 6—cladding in stone—double wall system; standard 6560—cladding with external thermal barrier; standard 1414 part 1—external plastering; standard 1414 part 3—External thermal plastering; and standard 1568—Ventilated facades.

All of these references are incorporated herein by reference in their entirety.

There is thus, a great need for, and it would be highly advantageous to have, a wet cladding method that will allow the advantages inherent to the method itself, allowing the use of industrialized cladding materials such as ceramic tiles, while avoiding the limitations associated with the use of stone and/or the method described in IL243159 and which complies with Israeli building standards.

### SUMMARY OF THE INVENTION

According to an aspect of the present invention there is provided a wet cladding kit for fixing an end cladding element to cementitious material of, or on, a backup wall, the kit comprising:
an undercut anchor configured for being inserted into a hole formed on a back surface of the end cladding element;
a flaring element configured for flaring said undercut anchor in said hole, said flaring element comprises a first portion of a connecting structure; and
a cementitious material engaging element which comprises at its proximal end a second portion of said connecting structure, said second portion of said connecting structure directly or indirectly connectable to said first portion of said connecting structure, said cementitious material engaging element further comprises a distal end extending from the second portion of the connecting structure for being embedded in the cementitious material;
wherein the first portion of the connecting structure and the second portion of the connecting structure are designed to be directly or indirectly potentially looseably connectable to form the connecting structure, so as to reduce a tendency of the undercut anchor from damaging walls defining the hole when a torque is applied onto the engaging element;
whereby the undercut anchor, the flaring element and the connecting structure are selected to provide a load bearing attachment between the cementitious material engaging element and the end cladding element, so as to provide mechanical fixing of the end cladding element to the cementitious material when the cementitious material is hardened.

According to embodiments of the invention, the first end of the connecting structure is directly connectable to the second end of the connecting structure.

According to embodiments of the invention, the first end of the connecting structure is indirectly connectable to the second end of the connecting structure.

According to embodiments of the invention, the cementitious material engaging element has a normal vector component in the distal end which, during service, is positioned parallel to the backup wall and the end cladding element.

According to embodiments of the invention, the normal vector component is formed, at least in part, by selecting the distal end of the cementitious material engaging element with a bend.

According to embodiments of the invention, the cementitious material engaging element is threaded at the distal end and wherein the normal vector component is formed at least in part by a threaded surface of the distal end.

According to embodiments of the invention, the kit further comprises a load dispersion element connectable to, or integrally formed with, the flaring element or the undercut anchor, wherein the load dispersion element is configured to disperse load over a surface area of the load dispersion element, the surface area being at least twice the surface area of the hole, so as to reduce load imposed by the undercut anchor on walls defining the hole.

According to embodiments of the invention, the second portion of the connecting structure is a connecting element selected from the group consisting of a washer shaped element, a closed ring, an open ring, a loop and a helix.

According to embodiments of the invention, the first portion of the connecting structure is a head structure of the flaring element.

According to embodiments of the invention, the flaring element is a threaded element configured to be received through the second portion of the connecting structure and into the undercut anchor to fix the cementitious material engaging element onto the back surface of the end cladding element.

According to embodiments of the invention, the kit further comprises end cladding elements.

According to embodiments of the invention, the kit further comprises a securing plate and a removable end cladding element securing agent for temporarily securing the end cladding element to a formwork.

According to embodiments of the invention, the kit further comprises water sealing strips attachable onto the back surface of adjacent the end cladding element, configured to seal gaps between the adjacent end cladding element, so as to prevent leakage of the cementitious material between a front surface of the end cladding elements and an outer sheet of a formwork and to water seal the wall once the cementitious material is hardened.

According to an aspect of the invention, there is provided a wet cladding system for fixing an end cladding element to cementitious material of or on a backup wall comprising:
at least one kit described herein; and
at least one end cladding element.

According to embodiments of the invention, the hole is an undercut hole.

According to embodiments of the invention, the hole is a blind hole which traverses a thickness of an end-cladding element, the blind hole having an opening on a back surface of the end-cladding element, the blind hole being defined by internal walls having a length and a substantially identical diameter along the length.

According to embodiments of the invention, the material has a plasticity and is sufficiently non-brittle, so as to allow flaring of the undercut anchor into the material without breaking the end-cladding element, the material having a retention force that allows rigid attachment of the undercut anchor to the end-cladding element.

According to embodiments of the invention, the end cladding element is fabricated from a synthetic material.

According to embodiments of the invention, the end-cladding element is fabricated from a pre-prefabricated cementitious material.

According to embodiments of the invention, the end-cladding element is a pre-fabricated cement board.

According to embodiments of the invention, the pre-fabricated cement board is a cement bonded particle board or a cement fiber board.

According to embodiments of the invention, the end cladding element is fabricated from a material selected from the group consisting of ceramic clay, porcelain, a high pressure laminate (HPL), concrete, Corian®, Caesarstone®, glass, slate and stone.

According to embodiments of the invention, the front surface of the end cladding element is lined with a removable protective cover.

According to embodiments of the invention, the end cladding element includes the hole pre-formed on the back surface.

According to embodiments of the invention, the end cladding element includes the undercut anchor inserted into the hole.

According to embodiments of the invention, the end cladding element includes the flaring element installed in the undercut anchor.

According to embodiments of the invention, the cementitious material engaging element is connected to the flaring element.

According to embodiments of the invention, the system comprises at least eleven kits per square meter of the end cladding element.

According to embodiments of the invention, the system further comprises a corner bracket configured for engaging two end cladding elements at a predetermined angle.

According to embodiments of the invention, the corner bracket is connectable to the end cladding element via undercut anchors and respective undercut holes.

According to embodiments of the invention, the system comprises:
at least two end cladding elements; and
at least one corner bracket fixed to at least one of the at least two end cladding elements.

According to embodiments of the invention, the water sealing strips seal gaps between adjacent end cladding elements.

According to embodiments of the invention, the system further comprises securing plates and removable end cladding element securing agents for temporarily securing the end cladding elements to an outer sheet of the formwork.

According to embodiments of the invention, the removable end cladding element securing agents are configured to be removable when the cementitious material is hardened.

According to another aspect of the invention, there is provided a method of wet cladding a backup wall, the method comprising:
(a) providing a plurality of kits described herein;
(b) providing a plurality of end cladding elements having back surfaces which comprise a hole;
(c) engaging a reinforcement metal mesh onto a backup wall to be cladded;
(d) engaging the kits in the undercut holes; and
(e) applying the cementitious material between the back surfaces of the plurality of end cladding elements and the backup wall with the cementitious material engaging elements penetrating into the cementitious material;
(f) allowing the cementitious material to harden with the cementitious material engaging elements penetrating therein, thereby providing mechanical fixing and chemical bonding of the plurality of end cladding elements to the cementitious material when the cementitious material is hardened, thereby wet cladding the backup wall.

According to embodiments of the invention, the hole is an undercut hole.

According to embodiments of the invention, the hole is a blind hole which traverses a thickness of the end-cladding element, the blind hole having an opening on a back surface of the end-cladding element, the blind hole being defined by internal walls having a length and a substantially identical diameter along the length.

According to embodiments of the invention, the method further comprises spacing the plurality of end cladding elements with spacers.

According to embodiments of the invention, the method further comprises removing cementitious material leakages from a front surface of the plurality of end cladding elements.

According to embodiments of the invention, the cementitious material engaging elements penetrate beyond and engages the reinforcement metal mesh.

According to still another aspect of the invention, there is provided a wet cladding method of constructing a cladded wall, the method comprising:
(a) providing a plurality of kits described herein;
(b) providing a plurality of end cladding elements formed with holes in back surfaces of the plurality of end cladding elements;
(c) providing a formwork having an outer sheet and an inner sheet;
(d) arranging the plurality of end cladding elements with a front surface thereof against a back surface of the outer sheet of the formwork;
(e) engaging the plurality of kits in the undercut holes;
(f) securing the inner sheet and the outer sheet of the formwork to one another with formwork securing elements;
(g) applying the cementitious material into the formwork; and
(h) allowing the cementitious material to harden with the cementitious material engaging elements penetrating therein, thereby providing the mechanical fixing and chemical bonding of the end cladding elements to the cementitious material when the cementitious material is hardened, thereby constructing the cladded wall.

According to embodiments of the invention, the applying is effected with a concrete pump.

According to embodiments of the invention, the method further comprises ultrasonically vibrating the cementitious material before the cementitious material is hardened.

According to embodiments of the invention, the method further comprises spacing the plurality of end cladding elements with spacers spaced on the back surface the outer sheet of the formwork.

According to embodiments of the invention, the spacers are integrally formed with or permanently attached to the outer sheet of the formwork.

According to embodiments of the invention, the method further comprises placing a reinforcement metal mesh between the plurality of end cladding elements and the inner sheet of the formwork.

According to embodiments of the invention, the method further comprises placing insulating building blocks against an inner surface of the inner formwork sheet.

According to embodiments of the invention, the method further comprises applying a plurality of water sealing strips onto the back surfaces of the plurality of end cladding elements, the water sealing strips configured to seal gaps between adjacent the plurality of end cladding elements, so as to prevent leakage of the cementitious material between the front surface of the plurality of end cladding elements and the outer sheet of the formwork and to water seal the wall once the cementitious material is hardened.

According to embodiments of the invention, the method further comprises:
(i) arranging an additional set of end-cladding elements with a front surface thereof against a back surface of an inner sheet of the formwork; and
(j) connecting cementitious material engaging elements with the end-cladding elements of the additional set, wherein steps (i) and (j) are carried out prior to step (f).

According to embodiments of the invention, the additional set of end-cladding elements are fabricated from a cementitious material.

According to embodiments of the invention, the additional set of end-cladding elements comprise pre-fabricated cement boards.

According to embodiments of the invention, the pre-fabricated cement boards are cement bonded particle boards or cement fiber boards.

According to embodiments of the invention, the connecting is via holes that are formed in back surfaces of the first set of end-cladding elements into which undercut anchors have been inserted.

According to embodiments of the invention, the holes are undercut holes.

According to embodiments of the invention, the holes are defined by internal walls having a length and a substantially identical diameter along the length.

According to embodiments of the invention, the connecting is via holes that are formed in sides of the additional set of end-cladding elements.

According to embodiments of the invention, the method further comprises un-securing the inner sheet and the outer sheet of the formwork from one another by removing the formwork securing elements and removing the formwork.

According to embodiments of the invention, the method further comprises removing cementitious material leakages from a front surface of the plurality of end cladding elements.

According to an aspect of the invention, there is provided a wet cladding method for constructing a cladded wall, the method comprising:
(a) providing a plurality of kits described herein;
(b) providing a plurality of end cladding elements formed with undercut holes on back surfaces of the plurality of end cladding elements;
(c) placing the plurality of end cladding elements inside an area defined by a horizontal framework;
(d) engaging the plurality of kits in the undercut holes;
(e) applying the cementitious material onto the back surfaces;
(f) allowing the cementitious material to harden with the cementitious material engaging elements of the kits penetrating therein, thereby providing mechanical fixing and chemical bonding of the plurality of end cladding elements to the cementitious material once hardened, thereby constructing the cladded wall.

According to embodiments of the invention, the method further comprises applying a plurality of water sealing strips onto back surfaces of the plurality of end cladding elements, the water sealing strips configured to seal gaps between adjacent the plurality of end cladding elements.

According to an aspect of the invention, there is provided a wet cladding method for constructing a cladded wall, the method comprising:
(a) providing a plurality of kits described herein;
(b) providing a plurality of end cladding elements formed with undercut holes on back surfaces of the plurality of end cladding elements;
(c) applying cementitious material into a horizontal framework;
(d) engaging the plurality of kits in the undercut holes;
(e) placing the plurality of end cladding elements with a back surface thereof onto the cementitious material;
(f) allowing the cementitious material to harden with the cementitious material engaging elements of the kits penetrating therein, thereby providing mechanical fixing and chemical bonding of the plurality of end cladding elements to the cementitious material once hardened, thereby constructing the cladded wall.

According to embodiments of the invention, the applying is effected with a concrete pump.

According to embodiments of the invention, the method further comprises placing a reinforcement metal mesh inside the cementitious material.

According to another aspect of the invention there is provided a wet cladding method, the method comprising:
(a) providing a plurality of the kits described herein;
(b) providing a plurality of end cladding elements formed with holes in back surfaces of the plurality of end cladding elements;
(c) providing a plurality of formworks, each the formwork having an outer sheet and an inner sheet;
(d) placing the plurality of end cladding elements with a front surface thereof against a back surface of the outer sheet of each the formwork;
(e) engaging the plurality of kits in the holes;
(f) securing the plurality of end cladding elements to the outer sheet of each the formwork so as to form a plurality of assemblages;
(g) hoisting the plurality of assemblages to a floor under construction and placing the plurality of assemblages adjacent to one another;
(h) placing a plurality of reinforcing elements against the back surface of the plurality of end cladding elements;
(i) optionally placing heat insulating building blocks against the plurality of reinforcing elements;
j) securing each the inner sheet and each respective the outer sheet of the plurality of formworks to one another with formwork securing elements, so as to form a continuous formwork unit;
(k) applying the cementitious material into the continuous formwork unit;
(l) allowing the cementitious material to harden with the cementitious material engaging element penetrating therein, thereby providing the mechanical fixing and chemical bonding of the end cladding elements to the cementitious material once hardened.

According to embodiments of the invention, the method further comprises securing the plurality of end cladding elements with securing plates and removable end cladding element securing agent to the outer sheet of the formwork.

According to embodiments of the invention, the method further comprises removing the removable end cladding element securing agent once the cementitious material is hardened.

According to embodiments of the invention, the method further comprises applying a plurality of water sealing strips onto the back surfaces of the plurality of end cladding elements, the water sealing strips configured to seal gaps between adjacent the plurality of end cladding elements, so as to prevent leakage of the cementitious material between the a front surface of the plurality of end cladding elements and the outer sheet of the formwork and to water seal the structure once the cementitious material is hardened.

According to embodiments of the invention, the method further comprises removing the formwork.

According to embodiments of the invention, the method further comprises:
(m) arranging an additional set of end-cladding elements with a front surface thereof against a back surface of an inner sheet of the formwork; and
(n) connecting cementitious material engaging elements with the end-cladding elements of the additional set, wherein steps (m) and (n) are carried out prior to step (j).

According to embodiments of the invention, the additional set of end-cladding elements are fabricated from a cementitious material.

According to embodiments of the invention, the additional set of end-cladding elements comprise pre-fabricated cement boards.

According to embodiments of the invention, the pre-fabricated cement boards are cement bonded particle boards or cement fiber boards.

According to embodiments of the invention, the connecting is via holes that are formed in back surfaces of the first set of end-cladding elements into which undercut anchors have been inserted.

According to embodiments of the invention, the holes are undercut holes.

According to embodiments of the invention, the holes are defined by internal walls having a length and a substantially identical diameter along the length.

According to embodiments of the invention, the connecting is via holes that are formed in sides of said additional set of end-cladding elements.

According to still another aspect of the invention there is provided a structure constructed using the methods described herein.

According to embodiments of the invention, the plurality of end cladding elements are tiles of a synthetic material.

According to embodiments of the invention, the structure further comprises a plurality of water sealing strips attached on the back surface of the plurality of end cladding elements, configured to seal gaps between adjacent the plurality of end cladding elements, so as to prevent leakage of the cementitious material between a front surface of the plurality of end cladding elements and the outer sheet of the formwork and to water seal the structure once the cementitious material is hardened.

According to embodiments of the invention, the sealing strip is a gasket.

According to embodiments of the invention, the structure comprises a plurality of securing plates arranged over edges of the back surface of contiguous pairs of the plurality of end cladding elements, the securing plates embedded in the cementitious material.

According to yet another aspect, there is provided a wet cladding method, the method comprising:
(a) attaching a plurality of cementitious material engaging elements to back surfaces of a plurality of cladding elements;
(b) arranging the plurality of cladding elements in a formwork; and
(c) adding cementitious material to the formwork, thereby providing mechanical fixing and chemical bonding of the end cladding elements to the cementitious material once hardened.

According to yet another aspect, there is provided a wet cladding method, the method comprising:
(a) attaching a plurality of cementitious material engaging elements to back surfaces of a plurality of cladding elements;
(b) adding cementitious material so as to provide mechanical fixing and chemical bonding of the end cladding elements to the cementitious material once hardened.

According to yet another aspect, there is provided a wet cladding method, the method comprising:
(a) attaching a plurality of cementitious material engaging elements to back surfaces of a plurality of cladding elements;
(b) arranging the plurality of cladding elements in a formwork;
(c) securing the plurality of end cladding elements with securing plates and removable end cladding element securing screw to the formwork; and
(d) adding cementitious material to the formwork, thereby providing mechanical fixing and chemical bonding of the end cladding elements to the cementitious material once hardened.

According to yet another aspect, there is provided a wet cladding method, wet cladding method, the method comprising:
(a) attaching a plurality of cementitious material engaging elements to back surfaces of a plurality of cladding elements;
(b) arranging the plurality of cladding elements in a formwork;
(c) sealing gaps between adjacent end cladding elements by applying a water sealing strips to the back surfaces so as to seal the gaps; and
(d) adding cementitious material to the formwork, thereby providing mechanical fixing and chemical bonding of the end cladding elements to the cementitious material once hardened.

According to yet another aspect, there is provided a cladded structure comprising:
(a) a plurality of cementitious material engaging elements engaged to back surfaces of a plurality of cladding elements; and
(b) hardened cementitious material;
   wherein the plurality of cementitious material engaging elements are engaged in the hardened cementitious material, thereby providing mechanical fixing of the end cladding elements to the hardened cementitious material, whereas the plurality of cladding elements are chemically bonded to the hardened cementitious material.

According to embodiments of the invention, the cladded structure further comprises water sealing strips attached on the back surface of adjacent the end cladding elements, configured to seal gaps between the adjacent end cladding elements, so as to prevent leakage of the cementitious material between a front surface of the adjacent end cladding elements and an outer sheet of a formwork and to water seal the structure once the cementitious material is hardened.

According to embodiments of the invention, the cladded structure further comprises securing plates for securing the plurality of end cladding elements with removable end cladding element securing agent to a formwork while casting the structure.

According to embodiments of the invention, the structure selected from the group consisting of a precast wall, a wall and a building.

According to embodiments of the invention, the structure further comprises a corner bracket connecting a pair of the plurality of end cladding element to one another at an angle.

According to embodiments of the invention, at least one of the plurality of cladding elements is a quadrangle having X and Y dimensions, whereby both X and Y are each independently greater than 35 cm.

According to embodiments of the invention, the chemical bonding pull strength exceeds 1 MegaPascal (MPs) per mm².

According to embodiments of the invention, at least eleven kits are provided per 35 kg of end cladding element.

According to embodiments of the invention, a pulling strength of the cladding element is at least 100 Kg/m².

According to embodiments of the invention, the second portion of the connecting structure is formed by forging.

According to yet another aspect there is provided a kit for connecting to one another a first end cladding element to a second end cladding element at a predetermined angle, the first end cladding element formed with a first undercut hole in a back surface thereof, the second end cladding element formed with a second undercut hole in a back surface thereof, the kit comprising:
(a) a corner bracket having a first arm having a first hole formed there through and a second arm having a second hole formed there through, the first arm and the second arm connected to one another directly or indirectly at the predetermined angle;
(b) a first undercut anchor and a second undercut anchor; and
(c) a first flaring element and a second flaring element;
wherein the first flaring element designed insertable through the first hole for flaring the first undercut anchor within the first undercut hole;
whereas the second flaring element designed insertable through the second hole for flaring the second undercut anchor within the second undercut hole;
thereby connecting the first end cladding element to the second end cladding element at the predetermined angle to one another.

According to yet another aspect there is provided a structure comprising a cladded corner supported by the kit of claim 96.

According to yet another aspect there is provided a method of securing an undercut anchor in a blind hole which traverses a thickness of an end-cladding element, the blind hole having an opening on a back surface of the end-cladding element, the blind hole being defined by internal walls having a length and a substantially identical diameter along the length, the method comprising:
inserting the undercut anchor into the blind hole;
screwing a flaring element into the undercut anchor, so as to allow the undercut anchor to flare inside the hole and beyond the internal walls of the hole, while compressing material of the end-cladding element surrounding the hole.

According to embodiments of the invention, the end-cladding element is fabricated from a material having a plasticity and being sufficiently non-brittle, so as to allow flaring of the undercut anchor beyond the walls of the hole without breaking the end-cladding element, the material having a retention force that allows rigid attachment of the undercut anchor to the end-cladding element.

According to embodiments of the invention, the flaring element is integrally formed with, or attachable to, an undercut anchor (UA) attaching end of a cementitious material engaging element.

According to embodiments of the invention, the end-cladding element is fabricated from a pre-prefabricated cementitious material.

According to embodiments of the invention, the end-cladding element is a pre-fabricated cement board.

According to embodiments of the invention, the pre-fabricated cement board is a cement bonded particle board or a cement fiber board.

According to yet another aspect there is provided an end-cladding element having a back surface which comprises a blind hole into which an undercut anchor has been flared and secured, the end-cladding element being fabricated from a material, wherein the material of the end-cladding element surrounding the undercut anchor, after the undercut anchor has been flared and secured, is more compressed than the material of the end-cladding element not surrounding the undercut anchor.

According to embodiments of the invention, the material has a plasticity and is sufficiently non-brittle, so as to allow flaring of the undercut anchor into the material without breaking the end-cladding element, the material having a retention force that allows rigid attachment of the undercut anchor to the end-cladding element.

According to embodiments of the invention, the material is a cementitious material.

According to embodiments of the invention, the end-cladding element is a pre-fabricated cement board.

According to embodiments of the invention, the pre-fabricated cement board is a cement bonded particle board or a cement fiber board.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A and 1B and 1C are respectively an example profile of a wet cladded wall and an example perspective view of a corner connection, both as depicted in Israel building standard 2378 Part 2;

FIGS. 2A, 2B and 2C are respectively a stone facade fixed to a metal formwork prior to casting of the wall according to the Baranovich method and an example profile of a wet cladded wall according the Baranovich method, as depicted in Israel building standard 2378 part 5;

FIGS. 3A and 3B are two examples of assembled systems, both in accordance with some exemplary embodiments of the invention;

FIGS. 4A and 4B is a back and sectional view of the example assembled system shown in FIG. 3A, in accordance with some exemplary embodiments, where FIG. 4B, presents for the first time, an assembled kit of the present invention engaging an undercut hole formed on the back surface of the end cladding element.

FIG. 5A is an example kit in accordance with some exemplary embodiments of the invention;

FIG. 5B is an example of an undercut hole on the back surface of an end cladding element;

FIGS. 6A, 6B, 6C and 6D are examples of cementitious material engaging elements, each including at a proximal end an example washer type portion of a connecting structure and at a distal end, a bend for being embedded in the cementitious material, all in accordance with some exemplary embodiments of the invention;

FIG. 6E is an image of an example engaging element including a bend in accordance with some exemplary embodiments of the invention;

FIG. 7 is a simplified drawing of an example engaging element with screw threads in a distal end in accordance with some exemplary embodiments of the invention;

FIGS. 8A, 8B, 8C and 8D are sectional views of four example kits assembled on an end cladding element, all in accordance with some exemplary embodiments of the invention;

FIGS. 9A, 9B and 9C are different views of an example load dispersion element in accordance of some exemplary embodiments of the invention;

FIG. 10A is an example assembled corner system in accordance with some exemplary embodiments;

FIG. 10B is a blow out of the corner bracket used in the exemplary corner system illustrated in FIG. 10A;

FIGS. 11A and 11B are different views of a securing plate assembly securing end cladding elements to an outer sheet of a formwork over gaps covered with a sealing strip in accordance with some exemplary embodiments of the invention;

FIGS. 12A and 12B are front and back views of four end cladding elements with sealing strips sealing gaps between the four end cladding elements in accordance with some exemplary embodiments of the invention;

FIG. 13 is an example securing plate assembly in accordance with some exemplary embodiments of the invention;

FIGS. 14A and 14B are a scheme and a photograph depicting an example outer sheet of a formwork including end cladding elements according with some exemplary embodiments of the invention while being hoisted to a floor under construction;

FIG. 15 is a photograph depicting removal of cement stains on the surface of a stone end cladding elements when the cladded wall has been cast according to the Baranovich method;

FIGS. 16A-C are photographs depicting the damage to a stone cladded wall due to ageing;

FIG. 17 is a photograph depicting the securing of end cladding elements to an outer sheet of a formwork and the inner shift of the formwork in accordance with some exemplary embodiments of the invention;

FIG. 18 is a simplified flow chart of an example method for wet cladding in accordance with some exemplary embodiments of the invention;

FIG. 19 is a simplified flow chart of an example method for wet cladding with formwork system in accordance with some exemplary embodiments of the invention;

FIG. 20 is a simplified flow chart of an example method for wet cladding in accordance with some exemplary embodiments of the invention;

FIG. 21 is a simplified flow chart of an example method for wet cladding in accordance with some exemplary embodiments of the invention;

FIGS. 22A-B is a simplified flow chart of an example method for wet cladding in accordance with some exemplary embodiments of the invention;

FIGS. 23A and 23B and 23C are illustrations of three stages in preparation of end-cladding element assemblies with uniform (non-undercut) holes, according to embodiments of the invention;

FIGS. 24A and 24B and 24C are illustrations of three stages in preparation of end-cladding element assemblies with undercut holes, according to embodiments of the invention; and

FIG. 25 is an illustration of a wall which is cladded on both the internal-facing surface and the external-facing surface, according to embodiments of the invention.

FIGS. 26A, 26B, 26C and 26D are respectively an alternate example system including an example kit with an example U-shaped element, two perspective views of the example kit and a sectional view of the example kit installed on an edge of an end cladding element, all in accordance with some example embodiments;

FIGS. 27A, 27B and 27C are two perspective views of another example kit with a U-shaped element and a sectional view of the example kit installed on an edge of an end cladding element, all in accordance with some example embodiments; and

FIGS. 28A and 28B are respectively a perspective view and a side view of yet another example kit including a U-shaped piece in accordance with some example embodiments.

### DESCRIPTION OF SPECIFIC EMBODIMENTS OF THE INVENTION

The present invention, in some embodiments thereof, relates to wall cladding kits, systems, methods and structures cladded therewith, more particularly, but not exclusively, to wet wall cladding kits, systems, methods and structures cladded therewith.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

According to some exemplary embodiments a wet cladding fixing kit for fixing an end cladding element to cementitious material of, or on, a backup wall, is provided.

The kit comprises an undercut anchor, configured for insertion into a hole (e.g. an undercut hole) formed on a back surface of the end cladding element. The kit further comprises a flaring element (typically, but not necessarily, a screw) which is configured for flaring the undercut anchor in the hole. The flaring element comprises a first portion of a connecting structure (typically, but not necessarily, a screw head).

The kit further comprises a cementitious material engaging element, typically a pin like element, having an elongated structure. The engaging element comprises at its proximal end a second portion of the connecting structure (typically, but not necessarily, a washer shaped element, an open ring, a closed ring, a helix or a loop). The second portion of the connecting structure is connectable, directly or indirectly, to the first portion of the connecting structure. The cementitious material engaging element further comprises a distal end extending from the second portion of the connecting structure for being embedded in the cementitious material. The second portion of the connecting structure is optionally formed by forging.

The term “proximal end” refers to the end, which after engagement (i.e. after construction of the cladded wall) is closest to the end cladding element. The proximal end of the cementitious material engaging element may be referred to as the undercut anchor attaching end. The term “distal end” refers to the end, which after engagement is furthest from the end cladding element. The distal end of the cementitious material engaging element may be referred to as the cement embedding (CE) end.

The first portion of the connecting structure and the second portion of the connecting structure are designed to be directly or indirectly potentially looseably connectable to form the connecting structure, so as to reduce the tendency of the undercut anchor from damaging walls defining the hole (e.g., undercut hole) when a torque is applied onto the engaging element. In other words, the tightness of the connection between the first portion of the connecting structure and the second portion of the connecting structure is adjustable, so as to be able to control the tendency of the undercut anchor from damaging walls defining the hole (e.g., undercut hole) when a torque is applied onto the engaging element. The undercut anchor, the flaring element and the connecting structure are selected to provide a load bearing attachment between the cementitious material engaging element and the end cladding element, so as to provide mechanical fixing of the end cladding element to the cementitious material when the cementitious material is hardened.

The tightness or looseness of the connection between the first and second portions or the connecting structure (when the kit is in service), is physically determined by the relative sizes of the inner portion of the undercut anchor, the length of the flaring element, the size of the first portion, the size of the second portion and the decision of the assembler of the kit, to what tightness or looseness to engage the parts together.

The tightness or looseness of the connection between the first and second portions or the connecting structure (when the kit is in service), is one of several crucial features of this exemplary embodiment of the invention, as is allows the use of the kit with a wide variety of cladding materials (ones that are softer than stone, harder than stone and/or more brittle than stone), with lesser risk of damaging the walls defining the hole (e.g. undercut hole) while maximizing the load bearing attachment between the cementitious material engaging element and the end cladding element. In an exemplary embodiment, in order to ascertain optimization, the relative physical sizes of the described parts of the kit are so selected such that when engaged at the tightest engagement possible, the walls defining the hole (e.g. undercut hole) remain intact when a torque is applied onto the engaging element. Such a torque is applied to the engaging element, for example, by the assembler of the kit. Other examples which are inherent to some uses of the kit will be described in more details below.

In any event, the pull strength of a single kit of the invention out of its respective holes (e.g. undercut holes) is several orders of magnitude higher as compared to existing wet cladding methods where the pins are inserted into holes formed on the side surface of the stone without any undercut associated pull resistance. So, when using for example the Baranovich method for wet cladding, many of the pins are misplaced and find themselves spread at the bottom of the wall, reducing the mechanical fixing of the facade to the backup wall as a whole. This can hardly happen with the kits of the present invention because of the undercut system which far better stabilizes the pins in their respective locations.

In any event, once the cementitious material hardens around the connecting structure, the attachment between the engaging element and the end cladding element becomes load bearing with little or no correlation to its initial looseness or tightness.

According to some exemplary embodiments of the invention, the loose attachment provided by the connecting structure may both simplify the casting process, when casting into a formwork as in wet cladding using the Baranovich method and may also improve the mechanical fixation strength of the end cladding elements to the backup wall. When constructing and cladding using the Baranovich method, it is known that whilst pouring concrete from a height and/or with pressure, aggregates within the concrete may repeatedly strike the metal pins fitted through pre-drilled holes extending within the stone end cladding element. Since in the Baranovich method, the metal pins are only loosely inserted into the stone end cladding element without being integrally connected to the stone end cladding element, striking of the aggregates can lead to the pins falling off the stone and accumulating at the bottom of the casted wall. Without all the metal pins engaging both the stone end cladding element and the backup wall, the mechanical fixing is compromised and the stones may fall over time due to ageing of the chemical bonding. In an attempt to prevent the metal pins from falling during casting, an old fashion concrete funnel is used in place of modern concrete pumps for pouring the concrete into the formwork. The funnel-poured concrete flows with much lower pressure as compared to flow with a concrete pump. With the reduced flow rate, the number of metal pins that are likely to fall off may be reduced. For the very same reason, concrete sonication is also not used in conjunction with the Baranovich method, as the sonication probe itself and/or the sonic energy may misplace the pins.

The invention overcomes this limitation by affording an undercut engagement for attachment of the cementitious material engaging element (e.g., pin) which creates a far stronger mechanical connection between the engaging element and the end cladding element, allowing the use of concrete pumps and sonicators.

As said, according to some exemplary embodiments of the invention, the connecting structure is configured to loosely connect the proximal portion of the engaging element to the end cladding element, so as to provide some give or freedom of movement while not allowing the proximal portion to disengage from the end cladding element. According to some exemplary embodiments, the loose attachment helps to reduce a torque that may otherwise be imposed on the undercut anchor and thereby reduce a tendency of said undercut anchor from damaging walls defining the hole (e.g. undercut hole), e.g., from breaking the end cladding element at the regions surrounding the undercut anchor.

As said, according to another example embodiment, the connecting structure is configured to tightly connect the proximal portion of the engaging element to the end cladding element, so that no give or freedom of movement is allowed. This embodiment is advantageous when the end cladding element is not brittle and forces applied to the walls defining the hole (e.g., undercut hole) therein are not likely to crack these walls, resulting in disengagement of the kit from the end cladding element.

Thus, unlike known wet cladding method, the present invention enables the use of concrete pumps which increases the rate and reduces the cost of construction and the use of concrete sonication probes which improve the strength and durability of the construction.

According to some exemplary embodiments, in order to engage the cementitious material, the cementitious material engaging element has a normal vector component in the distal end which, during service, is positioned parallel to the backup wall and the end cladding element, so as to increase the pull resistance of the engaging element from the cementitious material once hardened. This can be achieved, in any one of several ways, non-limiting examples include selecting the distal end (i.e., distal portion) with a bend and/or design at least a part thereof threaded, whereby the normal vector component is formed at least in part by the threaded surface. According to some exemplary embodiments, the kit provides components for forming a load bearing connection with end cladding elements having a wide range of thicknesses including thicknesses that are less than 3 cm, e.g., 1 cm-3 cm, less than 2 cm, e.g., 1.9 cm or less, or even 9-12 mm. According to some exemplary embodiments, the kit is suitable for cladding with porcelain ceramic tiles as well as with other tiles. The kit may be suitable for wet cladding other man-made (i.e., synthetic) materials, with naturally occurring stone or with slate. According to some exemplary embodiments of the invention, the end cladding element may have a water absorption of less than 0.5%. The end cladding elements may be of any shape (e.g., a polygon, such as rectangular or square; or combination of polygons having, for example, 5 and 6 gons to clad curved surfaces; or a non-polygon) and of any size—e.g., between 20 cm-5 meters in length and between 20 cm to 5 meters in height. According to some exemplary embodiments at least one of said plurality of cladding elements is a quadrangle having X and Y dimensions, whereby both X and Y are each independently greater than 35 cm. The back surface of the end cladding element may be smooth or rough. According to some exemplary embodiments of the invention, the back surface is artificially roughened to include a texture (e.g., grooves, holes, protrusions, scratches), so as to increase its surface area, thereby increasing the chemical bonding between the end cladding element and the cementitious material once hardened. In exemplary embodiments the chemical bonging exceeds 1 MegaPascal/mm² (MPa/mm²), see alternative values in Table 2 below. In exemplary embodiments at least 11 kits are provided per about 35 kg of end cladding element. In exemplary embodiments at least 11 kits are provided per about 1 m² of end cladding element.

According to exemplary embodiments, each corner of the end cladding element (e.g., tile) is connected to at least one kit on its back surface, e.g., at least four kits per tile. Depending on the size of the end-cladding elements, additional kits may be required or desired.

According to some exemplary embodiments, the end cladding elements may be pre-formed with the hole (e.g. undercut hole or uniform hole), e.g., during manufacturing. The uniform hole is a blind hole being defined by internal walls having a length and a substantially identical diameter along the length. In an exemplary embodiment, the hole is about 5-7 mm in diameter and about 4-7 mm in depth. According to exemplary embodiments, the end cladding element is formed with a plurality of holes (e.g. undercut holes), e.g., 4-8, 4-12 or 4-50 holes (e.g. undercut holes). According to exemplary embodiments a kit is engaged on each of the plurality of holes (e.g. undercut holes) formed on the back surface end cladding element.

According to some exemplary embodiments, the distal end of the engaging element is configured to provide the mechanical engagement with the cementitious material of the backup wall (or cementitious material on the backup wall) for wet cladding. The distal end (e.g., pin) may be the same or similar to the metal pins described in section 2378 Part 2 of the Israeli building standard, may be the same or similar to the metal pins described in section 2378 Part 5 of the Israeli building standard. In some exemplary embodiments of the invention the engaging element may be formed from a stainless steel rod that has a diameter of at least 3 mm-4 mm, e.g., 3.5 mm. According to some exemplary embodiments, larger diameter engaging elements may be used. The length of the part of the cementitious material engaging element that actually engages the cement or concrete may be between 50-100 mm for example, between 60-80 mm.

In some exemplary embodiments, the second portion of the connecting structure at the proximal end of the cementitious material engaging element is a washer type element, a closed ring, an open ring, a loop or a helix. According to some exemplary embodiments, the second portion of the connecting structure is cast together with the engaging element or forged together with the engaging element, or welded together as a single entity; namely an integral part. The engaging element may be formed from the same material defined in Israeli building standard section 2378 Part 2 or Part 5.

According to some exemplary embodiments the distal end of the engaging element includes one or more bend characterized by a normal vector component which when in service is positioned parallel to the wall and the end cladding element and serves to increase the retention of the engaging element in the cement According to some exemplary embodiments, the distal end of the engaging element has a threaded surface. According to some exemplary embodiments, the bend or surface with normal vector component parallel to the end cladding element provides the mechanical fixing with the cementitious material once the cementitious material is dried and hardened. According to an exemplary embodiment of the invention the pulling strength of the kit from an end cladding material is selected over 10 Kg pull strength, optionally over 20 Kg pull strength, optionally over 40 Kg pull strength optionally about 10 Kg pull strength. According to an exemplary embodiment of the invention the pulling strength of an end cladding element from a cladded wall is at least 100 Kg/m², optionally at least 500 Kg/m², optionally at least 1000 Kg/m², optionally at least 1500 Kg/m², optionally at least 2000 Kg/m², optionally at least 2300 Kg/m².

According to an exemplary embodiment of the invention, the kit further comprises a load dispersion element. The load dispersion element is connectable to, or integrally formed with, the flaring element or the undercut anchor. The load dispersion element is configured to disperse load over a surface area of the load dispersion element, so as to reduce load imposed by the undercut anchor on walls defining the hole (e.g. undercut hole).

In some exemplary embodiments of the invention the actual use and the size and shape of the load dispersion element is one of several crucial features, as it allows the use of the kit with softer and/or more brittle end cladding materials, with lesser risk of damaging the walls defining the hole (e.g. undercut hole) when a torque is applied to the cementitious material engaging element, while maximizing the load bearing attachment between the cementitious material engaging element and the end cladding element. Such torque is applied to the engaging element, for example, by the assembler of the kit. Other examples which are inherent to some uses of the kit will be described in more details below. Thus, the load dispersion element is placed tightly against the back surface of the end cladding element to relieve lateral forces and blows by spreading the force over a larger surface area. The load dispersion element may be a plate and/or a washer that is according to exemplary embodiments made of metal, e.g., steel. According to some exemplary embodiments of the invention, the load dispersion element is about 40 mm in diameter. According to some exemplary embodiments, the load dispersion element is sandwiched between the first portion of the connecting structure and the back surface of the end cladding element surrounding the hole (e.g. undercut hole). According to some exemplary embodiments of the invention, the load dispersion element is integrally formed with the first portion of the connecting structure and is pressed against the back surface of the end cladding element surrounding the hole (e.g. undercut hole).

According to some exemplary embodiments of the invention, the load dispersion element is integrally formed with the undercut anchor and is pressed against the back surface of the end cladding element surrounding the hole (e.g. undercut hole).

As will be further delineated below, when the kit is used for generating precast cladded walls or wall cladding with the Baranovich method, the kit may according to some exemplary embodiments further comprise water sealing strips attachable onto the back surface of the end cladding element, configured to seal gaps between adjacent end cladding elements, so as to prevent leakage of the cementitious material between a front surface of the end cladding elements and an outer sheet of a formwork and/or to water seal the backup wall or precast wall once the cementitious material is hardened, thereby minimizing the amount of cleaning necessary once the cladded wall is constructed and minimizing water (e.g., rainfall) ingress behind the end cladding elements, which reduces the ageing of the cladding and the wall or structure as a whole. According to exemplary embodiments, the sealing strips are mounted over edges of pairs of adjacent end cladding elements on their back surfaces to cover the gaps formed there between. According to some exemplary embodiments, the scaling strip is a gasket. According to some exemplary embodiments, the sealing strip is an ethylene propylene diene monomer sheet or other rubber or silicone sheet. According to some exemplary embodiments, the sealing strip may have a thickness of 0.5 mm-1 cm, e.g., about 1 mm. Different colored sealing strips may be applied for aesthetic purposes.

As will be further delineated below, when the kit is used for generating precast cladded walls or wall cladding with the Baranovich method, the kit may according to some exemplary embodiments further comprise a securing plate and an end cladding element securing agent, for temporarily securing the end cladding element to the formwork.

A system according to exemplary embodiments of the present invention is meant to include at least one kit as described herein and at least one end cladding element at any assembling state, from being all disassembled to being all assembled onto a cladded wall or structure. The end cladding elements are preferable pre-formed with holes (e.g. undercut holes) on the back surface, although such holes can also be formed on site of construction.

The end cladding element can be of made of any material. In an exemplary embodiment, it is fabricated from a synthetic material. In an exemplary embodiment, it is fabricated from a natural material. In an exemplary embodiment the end cladding element is fabricated from a material such as, but not limited to, ceramic clay, porcelain, a high pressure laminate (HPL), concrete, Corian®, Caesarstone®, glass, and stone. It will be appreciated that when a non-undercut hole is drilled into the back surface of the end cladding element, the end cladding element is fabricated from a material having a plasticity and being sufficiently non-brittle, so as to allow flaring of the undercut anchor beyond the walls of the hole without breaking the end-cladding element, the material having a retention force that allows rigid attachment of the undercut anchor to said end-cladding element. Examples of such materials include pre-fabricated cementitious materials including pre-fabricated cement boards.

In an exemplary embodiment, the front surface of the end cladding elements are lined with a protective cover. According to some exemplary embodiments the protective cover is configured to protect the front surface of the end cladding element from being soiled with cementitious material during casting. The protective cover may be fabricated from any material (e.g., nylon) that is removable once the cladding or cladded wall construction is completed.

In an exemplary embodiment, at least eleven kits are used per square meter of the end cladding element.

A major design challenge of the Baranovich cladding system is sealing the cladding layer cladded onto the underlying backup wall. As is described in the background section above, the Baranovich cladding system is not water sealed for three reasons. Liquids can leak through gaps formed between the end cladding elements in regions of the pins and in locations where the “chochla” seal is compromised, as well as through the holes formed in the outer formwork sheet which serve for insertion of the barbed wire, and more so through the bolts dedicated holes.

That and more. For reasons delineated in the Background section above, currently, wet cladding methods are limited to the use of stone. Stone, as well as “chochla” as well as cement as well as concrete are all water absorbing materials and therefore water scaling a cladded wall cladded by any existing wet cladding method is an impossibility. Stone is so inherently water soaking that, when wet cladding using the Baranovich method, the back surfaces of the end cladding elements are sprayed with a sealing primer, so as to prevent cement stains of the cladded façade caused by the stones soaking cement through the back surfaces and the entire thickness thereof. However, this is problematic as the sealing primer has the adverse effect of reducing the chemical bonding between the backup wall and the end cladding elements.

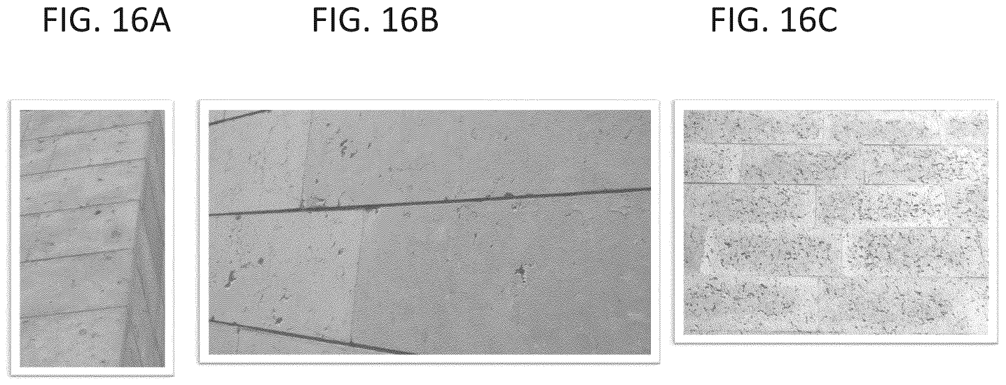

Water damage to stone cladding is evident for example in the photographs of FIGS. 16A, 16B and 16C. Use of water sealed synthetic end cladding elements such as, for example, ceramic porcelain could have eliminated this limitation, however, it is not afforded by currently available wet cladding methods, because the thickness of ceramic porcelain, for example, is ca. 9-12 mm, not allowing forming holes on the sides thereof and/or engaging sufficiently thick pins therein.

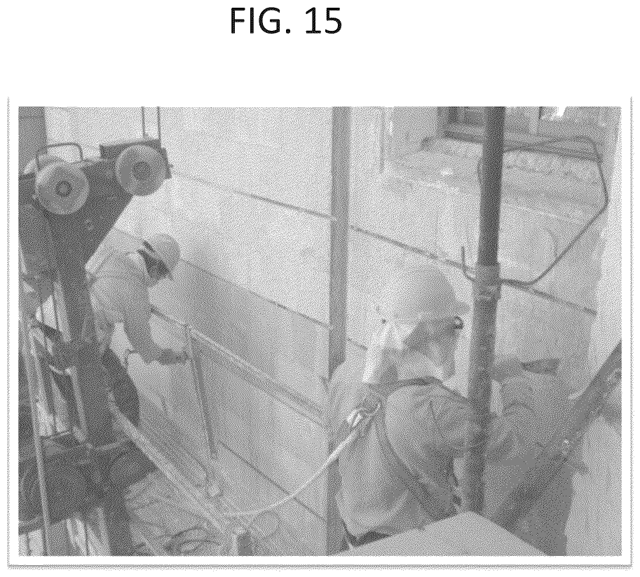

Irrespective of the type of material used for end cladding exterior-facing surfaces of walls, sealing gaps formed between adjacent end cladding elements of the cladding layer has at least three functions. During construction, it limits the amount of liquid cement that can spill through gaps formed between adjacent end cladding elements and soil the front surface thereof. FIG. 15 is a photograph showing workers cleaning a cladded wall constructed using the classical Baranovich method, this is both time consuming and expensive. During service, it limits the amount of water (e.g., rainfall) that can leak through gaps formed between adjacent end cladding elements and be absorbed the underlying backup wall, damaging the mechanical fixing and chemical bonding of the end cladding elements to the underlying backup wall and damaging the underlying wall itself. If not water sealed, a backup wall can absorb a substantial amount of water, reducing its inherent thermal insulation. By water sealing the gaps between adjacent end cladding elements, the underlying wall does not wet and its inherent thermal insulation maintained uncompromised.

Irrespective of the wet cladding method used, sealing gaps formed between adjacent end cladding elements is not practical because of the pins extending from the sides (thickness) of the end cladding elements.

The present invention overcomes this particular problem by engaging the end cladding elements from and the back surfaces thereof and not their sides (thickness). This, in turn, allows scaling the gaps between adjacent end cladding elements, resulting in water sealing the entire cladded façade.

When wet cladding using the Baranovich method, liquids can leak not only through gaps formed between the end cladding elements in regions of the pins and in locations where the “chochla” seal is compromised, but also through the holes formed in the outer formwork sheet which serve for insertion of the barbed wire, and more so through the bolts dedicated holes.

As described in the Background section above, the barbed wire is used to tie the outer formwork sheet to the fortification metal mesh, caging the end cladding elements there between, so as to avoid misplacement of the end cladding elements upon hoisting this assemblage to a floor under construction.

The presently described methods and systems overcome this problem as the engaging elements extend from a back surface of the end cladding element and thereby do not penetrate the gaps between the end cladding elements. Based on this design, a gasket or other sealing strip may be positioned along gaps between adjacent end cladding elements for superior insulation. In some exemplary embodiments, when ceramic porcelain end cladding elements are used, porcelain itself is water resistant, e.g., it does not absorb water. Thus, the front surface of a porcelain tile is water resistant, whereas the back surface is able to absorb water increasing the ability to chemically glue the tile with cement onto the backup wall. In these embodiments, thermal and water insulation may be provided using the sealing strips. Another advantage of the scaling strips is that they prevent leakage of the cementitious material through the gaps during casting. Leakage is known to occur in the Baranovich system. When cladding with stone that is porous and water-absorbing as in the Baranovich system, the cleaning process is both complicated and expensive. Rather, sealing as described herein may avoid leakages and prevent subsequent cleaning steps.

In some exemplary embodiments, the system additionally includes securing plates to secure the end cladding elements against a formwork (i.e., a temporary mold into/onto which liquid concrete may be poured). In some exemplary embodiments, securing plates are mounted over edges of pairs of adjacent end cladding elements on their back surfaces. According to some exemplary embodiments, the securing plates are mounted over the sealing strip. The securing plate may be metal or other material, e.g., an acetal homopolymer such as Derlin® manufactured by DuPont in Delaware USA. According to some exemplary embodiments, the securing plate is instead of ties that are known to be used in for example the Baranovich system. In some exemplary embodiments, each of the securing plates is fixed to the formwork with a securing element that extends from a securing plate to the formwork through the spacing between the end cladding elements. According to some exemplary embodiments, if a spacer is used to space the end cladding elements, (i.e., to space one adjacent end cladding element from another and/or to space a first row of end cladding elements from a second row of end cladding elements) the securing element penetrates the spacer. According to exemplary embodiments, the securing element is configured to be removed after the casted wall has hardened and dried. In some exemplary embodiments, the securing element is a threaded element, e.g., a bolt that is secured to the formwork with a threaded nut. In some exemplary embodiments, the threaded engagement of securing element prevents leakage of the cementitious material during casting. In the Baranovich system, holes through which the ties are introduced are known to be openings that allow cement to leak through during casting. By using the system and method as described herein, this leakage may be prevented.

According to an aspect of some exemplary embodiments, elements of the system are packaged and delivered to the construction site. According to some exemplary embodiments, the end cladding elements are formed with holes (e.g. undercut holes) prior to delivery of the system. According to some exemplary embodiments, the system is delivered in an assembled state or partially assembled state. According to some exemplary embodiments, the system is fully or partially assembled at the construction site.

According to an aspect of some exemplary embodiments, the wet cladding method includes providing a plurality of wet cladding systems, forming hole(s) (e.g. undercut hole(s)) if not already formed on the end cladding elements of the system, assembling the systems if not already assembled and wet cladding the backup wall with the assembled system. According to exemplary embodiments, a reinforcement metal mesh is engaged on the backup wall prior to wet cladding.

According to an aspect of some exemplary embodiments, the wet cladding method includes providing a plurality of kits, providing plurality of cladding elements formed with holes (e.g. undercut holes), and providing a formwork. In some exemplary embodiments, the cladding elements are positioned with a front surface against an outer sheet of the formwork and the plurality of kits are engaged in the holes (e.g. undercut holes). According to some exemplary embodiments, the kits may be installed on the end cladding elements prior to arranging the end cladding elements on the formwork. In some exemplary embodiments, an inner sheet of the formwork (which may or may not include a thermal or sound insulating layer) is then secured to the outer sheet with spacing therebetween in which the engaging elements are extended and the cementitious material is added within the spacing. The thermal insulating layer may be fabricated from materials including, but not limited to fiberglass, mineral wool, cellulose, polystyrene, polyurethane and cementitious foam.

Reinforcing elements, e.g., reinforcing bars, such as a metal grid, may be positioned within the spacing between the front and inner sheet of the formwork. According to some exemplary embodiments, the end cladding elements are spaced with dedicated spacers. According to some exemplary embodiments, the gaps are covered with a water scaling strip. According to some exemplary embodiments, the end cladding elements are secured to the formwork with a plurality of securing plates. In some exemplary embodiments, the formwork includes a plurality of sub-units that are fitted together.

According to an aspect of some exemplary embodiments, there is provided a structure that is cladded with the kit, system and methods described herein. The structure may comprise a wall which is cladded on its exterior facing surface, on its interior facing surface and optionally on both its exterior and interior facing surface.

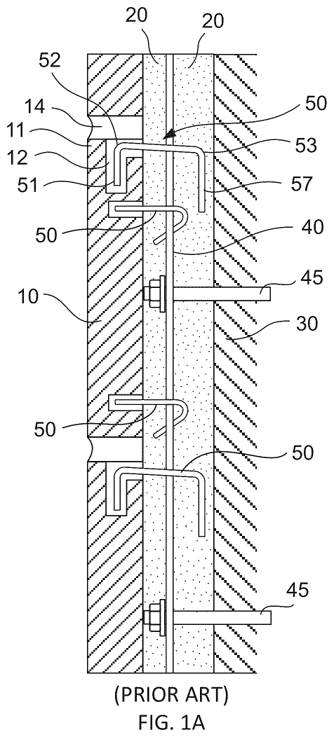

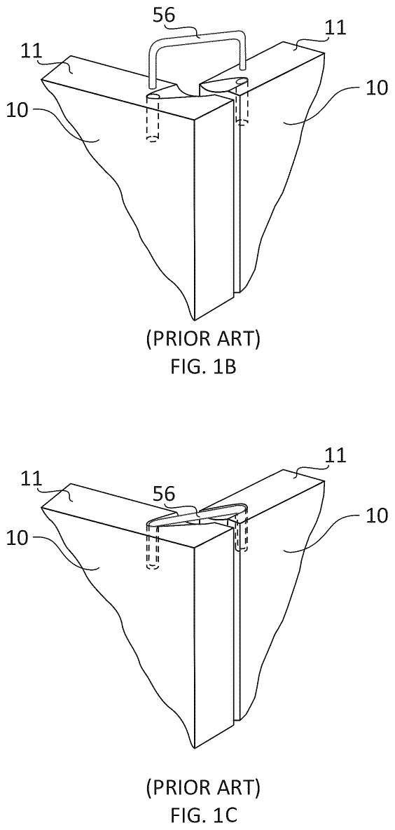

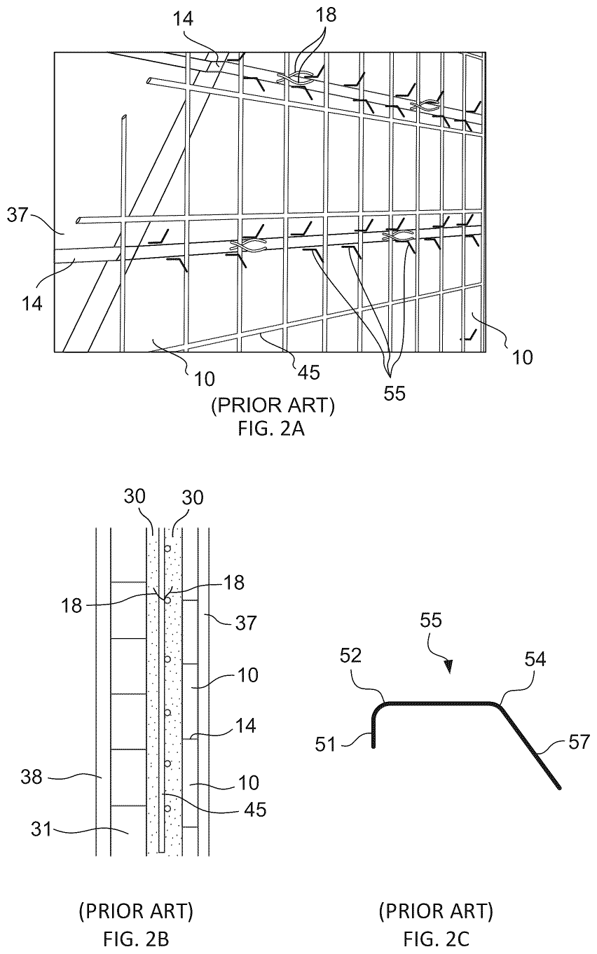

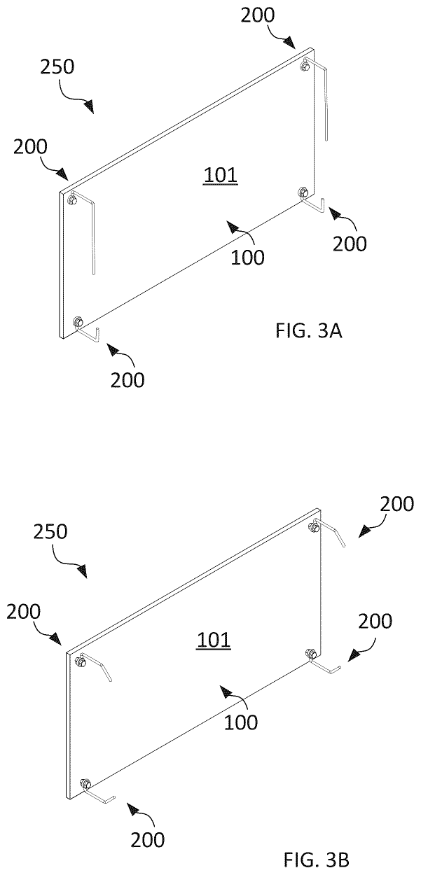

For purposes of better understanding some embodiments of the present invention, as illustrated in FIGS. 3B-22A-B of the drawings, reference is first made to the construction and operation of known wet cladding system as illustrated in FIGS. 1A-2B.

Reference is now made to FIGS. 1A and 1B showing respectively an example profile of a wet cladded wall and an example perspective view of a corner connection, both as depicted in Israel building standard 2378 Part 2. In FIG. 1A a backup wall 30 is cladded with a plurality of end cladding elements 10. Cladding relies on both chemical bonding (i.e., gluing) end cladding element 10 to backup wall 30 with cementitious material 20 and mechanical fixing of end cladding element 10 to backup wall 30 with a plurality of engaging elements (e.g., pins) 50. To provide the mechanical fixing with the engaging element 50, a drill hole 12 is first formed through an edge surface 11 of end cladding element 10 and a reinforcement metal mesh 40 is supported on backup wall 30 with fixing element 45. Cementitious material 20 is applied on backup wall 30 over reinforcement metal mesh 40 and on a back surface of end cladding element 10. Engaging element 50 is then inserted into drill hole 12 at its proximal end 51 and physically engaged with reinforcement metal mesh 40 at its opposite distal end 57. Proximal end 51 is loosely received by drill hole 12 and therefore positioning of proximal end 51 into drill hole 12 does not provide a load bearing connection. Engaging element 50 is typically formed with a first bend 52 and a second bend 53. First bend 52 provides receiving proximal end 51 into drill hole 12 and second bend 53 provides folding or hooking a distal end of engaging element 50 onto reinforcement metal mesh 40. Engaging element 50 is fixed onto reinforcement metal mesh 40 while cementitious material 20 is wet and is an integral part of cementitious material 20 when cementitious material 20 hardens. Proximal end 51 of engaging elements 50 may be received through upper, side and lower edges surfaces of end cladding element 10. Mortar 14 is typically used to fill gaps between end cladding elements 10. Based on building standard 2378 part 2, end cladding element 10 is required to have a thickness of 20-30 mm to accommodate forming drill hole 12 and receiving engaging element 50. Reinforcement metal mesh 40 is made of carbon steel and engaging element 50 is made from stainless steel. End cladding element 10 is required to be natural stone, although artificial stone can also be used.

Referring now to FIGS. 1B-C, a corner connection is made based on arranging a pair of end cladding elements 10 at right angles and inserting a corner engaging element 56 through an edge surface 11 of each end cladding element 10. End cladding element 10 is required to have a thickness of 20-30 mm to accommodate forming drill hole 12.

Reference is now made to FIGS. 2A, 2B and 2C respectively showing a back side of stone facade fixed to a metal formwork 37 prior to casting of the wall according to the Baranovich method, an example profile of a wet cladded wall and an example metal engaging element (i.e., pin) according the Baranovich method. In the Baranovich method described in Israeli building standard 2378 part 5, end cladding elements 10 are arranged on a first (outer) metal formwork 37 prior to casting backup wall 30. Metal engaging elements 55 are positioned in drill holes formed through edge surfaces of end cladding elements 10 as described in reference to engaging elements 50 (FIG. 1A). Each end cladding element 10 typically includes four engaging elements 55. Engaging elements 55 typically include a first bend 52 and a second bend 54. First bend 52 in engaging elements 55 is similar to bend 52 in engaging element 50. Proximal end 51 is inserted into a drill hole 12 of end cladding element 10. Second bend 54 is a bend with an obtuse angle. Distal end 57 is not required to physically engage a reinforcement metal mesh 45 but rather provides for improved anchoring of engaging element 55 into cementitious material once hardened and dried. Gaps between end cladding elements 10 are sealed with mortar (known as “chochla”) 14 on first formwork 37. Reinforcement metal mesh 45 is then positioned to face the back-surface of end cladding elements 10 leaving gaps through which the distal ends 57 of engaging elements 55 penetrate. Ties 18 are typically used to temporarily tie formwork 37 to reinforcement metal mesh 45, thereby securing end cladding elements 10 to first formwork 37. A second (inner) metal formwork 38, typically arranged with thermally insulating concrete blocks 31, is placed on an opposite side of reinforcement metal mesh 45 and cementitious material is poured to fill the gap there between. Cementitious material forms the backup wall 30 and also serves as the chemical bonding (i.e., gluing) agent that maintains the entire structure including end cladding elements 10 as single entity.

Reference is now made to FIGS. 3A and 3B showing two example assembled systems, all in accordance with some exemplary embodiments. According to some exemplary embodiments, a system 250 includes an end cladding element 100 with one or more kits 200 installed on a back surface 101 of end cladding element 100, each kit 200 includes a cementitious material engaging element 50 configured for wet cladding. According to exemplary embodiments, end cladding element 100 includes four kits 200, one for each corner of end cladding element 100. In some exemplary embodiments, system 250 includes a pair of upper engaging elements 50 fixed to two upper corners of end cladding element 100 and a pair of lower engaging elements 50 fixed to two lower corners of end cladding element 100.

In some exemplary embodiments, system 250 include engaging elements 50 with a cement engaging element formed with a 90 degree bend, e.g., similar to bend 53 of engaging elements 50 used in Israeli building standard 2378 Part 2, as illustrated in FIG. 3A. In other exemplary embodiments, illustrated in FIG. 3B, system 250 includes engaging elements 55 with distal end 205 similar to the distal end 57 of engaging elements 55 used in the Baranovich method, which is illustrated in FIG. 2C.

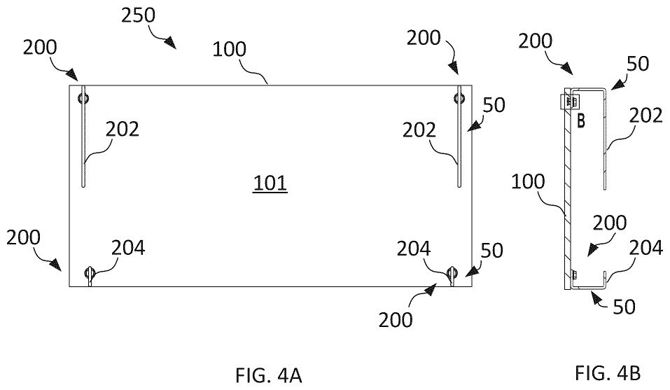

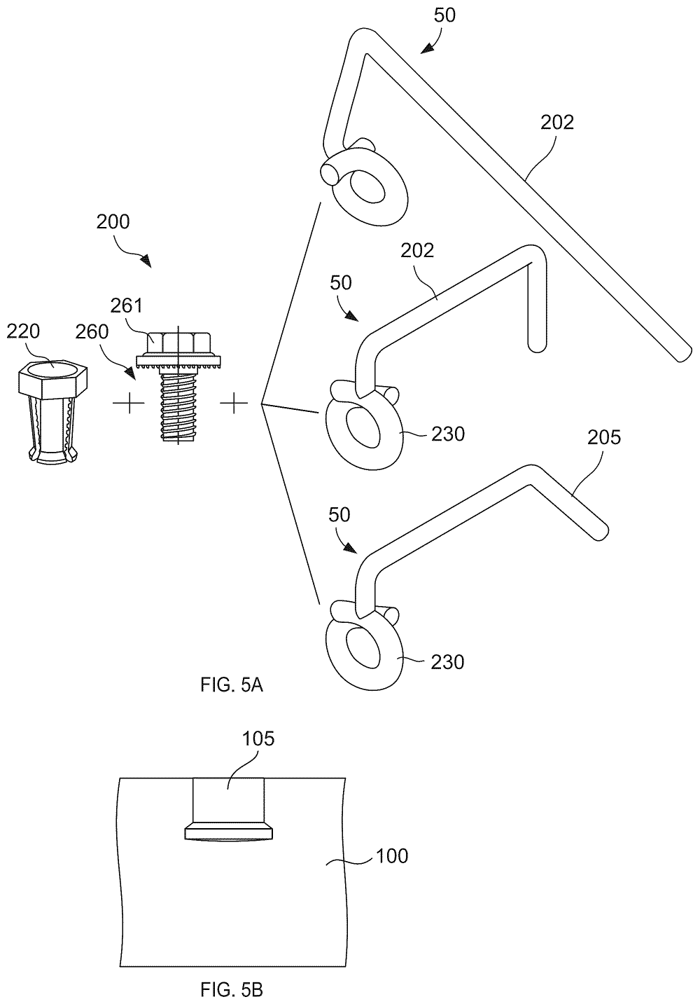

Reference is now made to FIGS. 4A and 4B which show a back and sectional view of the example assembled system of FIG. 3A. FIG. 4B is the first illustration demonstrating the type of connection between elements 50 and 100, better viewed and described in FIGS. 5A and 5B. According to some exemplary embodiments, upper engaging elements 50 include a longer distal end 202 as compared to a relatively shorter distal end 204 of lower engaging elements 50.

Reference is now made to FIG. 5A which illustrates the components of a kit in accordance with some exemplary embodiments and to FIG. 5B which illustrates undercut hole 105 formed in end cladding element 100. According to some exemplary embodiments, kit 200 includes an undercut anchor 220 configured to be received in an undercut hole 105 formed on back surface 101 of end cladding element 100, a flaring element 260 and a cementitious material engaging element, e.g., engaging element 50 or engaging element 55. Flaring element 260 may include a first portion 261 of a connecting structure for connecting with a second portion 230 of a connecting structure. According to some exemplary embodiments, the connection is defined to be loose so that engaging element 50 can wobble and/or move with respect to flaring element 260. Flaring element 260 may be a screw, bolt, or stud that is configured to flare undercut anchor 220 with a screwing or bolting motion. According to some exemplary embodiments, first portion 261 of the connecting structure is a head of the screw, bolt or stud. The connecting structure comprises first portion 261 of flaring element 260 directly or indirectly connected to second portion 230 of cementitious material engaging element 50 or 55. The tightness of the connection between the two can be controlled as further described hereinabove and hereinunder. According to some exemplary embodiments, flaring element 260 may be a rod that is configured to flare undercut anchor 220 based on being pushed or hammered into undercut anchor 220.

According to some exemplary embodiments, the engaging element, e.g., engaging element 50 or engaging element 55, in kit 200 includes a proximal end with a connecting element (i.e., a second portion of a connecting structure) 230 and distal end with a cement engaging element, e.g., distal end 204 (actually a pin structure) or 202. According to some exemplary embodiments, flaring element 260 may be received through connecting element 230 and may fix connecting element 230 against back surface 101 as flaring element 260 penetrates into undercut anchor 220. According to some exemplary embodiments, kit 200 provides a load bearing support to end cladding element 100. It is noted that engaging element 50 with distal end 205 is shown as an example. In other examples, engaging elements 50 with connecting elements 230 may include distal end 202 or engaging elements 55 with connecting elements 230 may include cement engaging element or distal end 205.

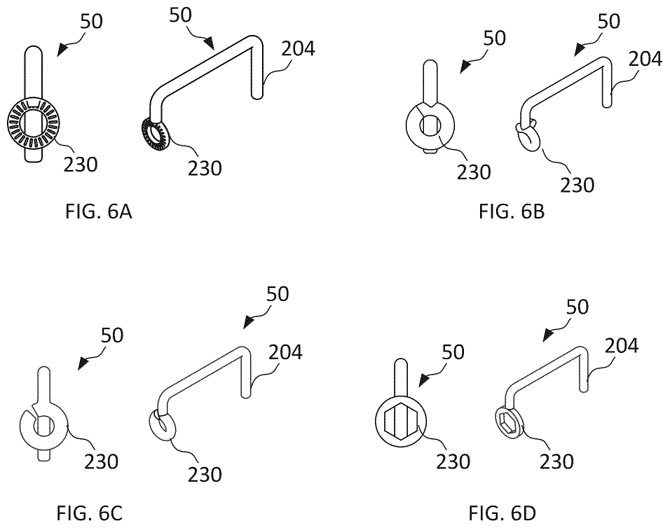

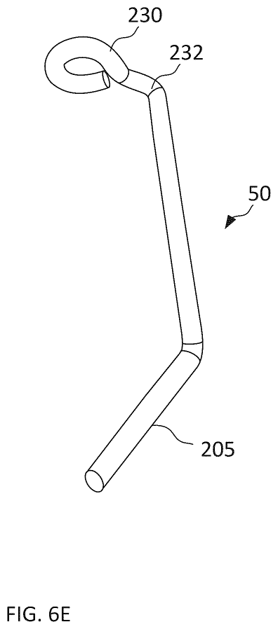

FIGS. 6A, 6B, 6C and 6D are exemplary cementitious material engaging elements, each including at a proximal end an example washer type portion of a connecting structure and at a distal end, a bend for being embedded in the cementitious material, all in accordance with some exemplary embodiments. A variety of connecting elements 230 are shown for a cementitious material engaging element 50 with distal end 204 as an example. The same variety of connecting elements 230 may also be contemplated for each of engaging elements with distal ends (cement anchoring elements) 202 and 205. In one example, connecting element 230 of a cementitious material engaging element 50 may be shaped as a flat ring or flat washer as shown in FIG. 6A. In another example connecting element 230 is helical as shown in FIG. 6B. The helical shaped connecting element 230 may function as a spring washer. In yet another example, connecting element 230 may be an open loop that is formed based on bending a proximal end of engaging element 50 (FIG. 6C). In yet another example, connecting element 230 may be a flat ring or flat washer shaped element with a hexagonal bore (FIG. 6D) through which flaring element 260 is received. Connecting elements 230 are integral to the engaging element 50. According to some exemplary embodiments, the engaging element 50 is cast together with connecting element 230. Alternatively, connecting element 230 is welded or otherwise fixed onto a proximal end of the engaging element 50.

FIG. 6E is an image of an example engaging element 50 in accordance with some exemplary embodiments. In FIG. 6E engaging element includes a connecting element 230 at its proximal end that is configured to be positioned flush against a back surface of an end cladding element, a bend 232 configured to extend engaging element 55 in a direction normal to the back surface of the end cladding element, a distal end 205 at its distal end optionally in a form of a bend.

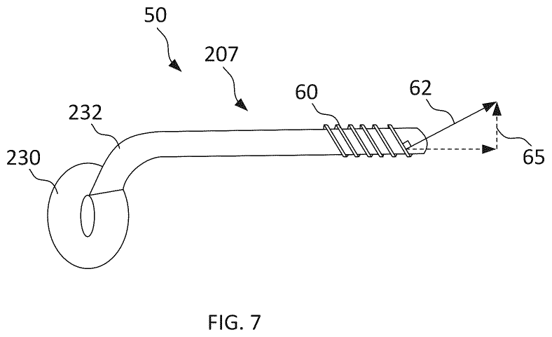

FIG. 7 is a simplified drawing of an example engaging element with screw threads in a distal end in accordance with some exemplary embodiments. In some exemplary embodiments, engaging element 50 does not include a bend in a distal end but rather includes a threading 60. In some exemplary embodiments, a normal vector 62 to a surface of threading 60 includes a vector component 65 that is perpendicular to the distal end 207 of engaging element 50. In some exemplary embodiments, the normal vector 62 to a surface of threading 60 includes a vector component 65 that is also parallel to the distal end 207 of engaging element 50. The distal end 207 is elongated, characterized by a longitudinal axis, and the threading 60 is at an angle, preferably an acute angle, to the longitudinal axis. In some exemplary embodiments, vector component 65 of thread 60 improves mechanical engagement of engaging element 50 with the cementitious material when penetrating the cementitious material and prevents engaging element 50 from being pulled out of the cementitious material when it dries.

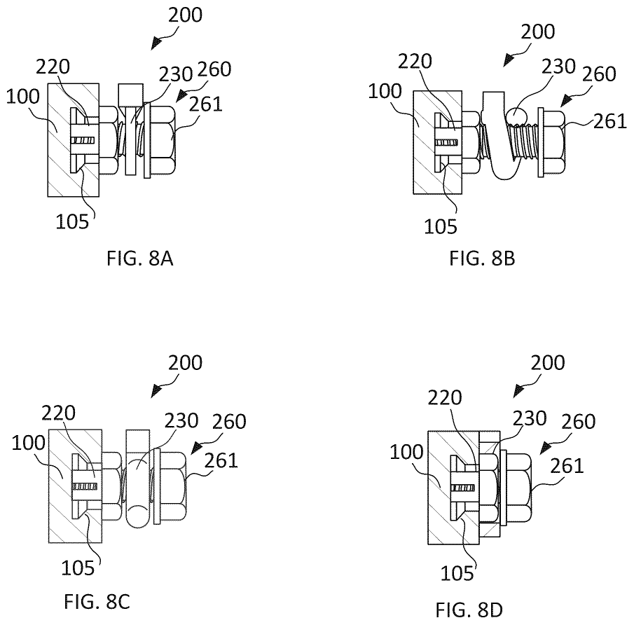

FIGS. 8A, 8B, 8C and 8D are sectional views of four example kits assembled on an end cladding element, all in accordance with some exemplary embodiments. According to some exemplary embodiments, an undercut hole 105 is formed through a back surface of end cladding element 100 and kit 200 is configured to be assembled onto end cladding element 100 through undercut hole 105. Undercut anchor 220 may be inserted into undercut hole 105 and flaring element 260 may be positioned through connecting element 230 and into undercut anchor 220. Insertion of flaring element 260 is configured to flare undercut anchor 220 and thereby fix connecting element 230 against back surface of end cladding element 100. A connectable structure is formed with connecting element 230 being a first portion of the connecting structure and head 261 of flaring element 260 being a second portion of the connecting structure. FIG. 8A shows an example assembly with a flat ring or flat washer type connecting element 230 shown in FIG. 6A. FIG. 8B shows an example assembly with a spring washer type connecting element 230 shown in FIG. 6B. FIG. 8C shows an example assembly with an open loop shaped connecting element 230 shown in FIG. 6C. FIG. 8D shows an example assembly with a flat helical type connecting element 230 shown in FIG. 6D. In some exemplary embodiments, flaring element 260 fixes connecting element 230 against a back surface of end cladding element 100 with a desired degree of give or freedom.

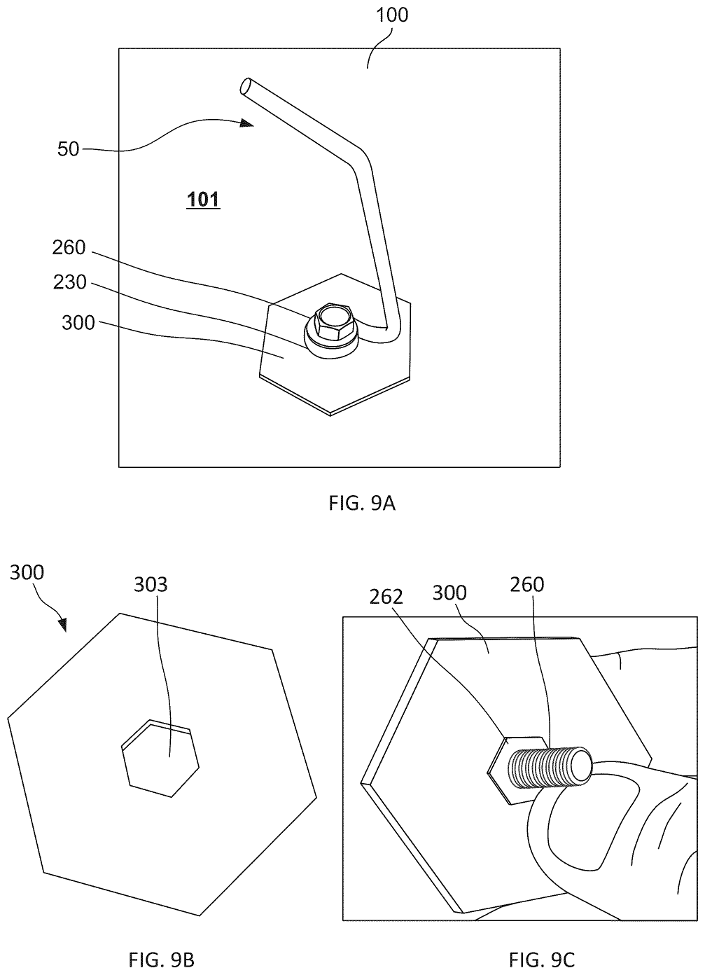

FIGS. 9A, 9B and 9C are different views of an exemplary load dispersion element in accordance with some exemplary embodiments. According to some exemplary embodiments, load dispersion element is positioned against back surface 101 of an end cladding element 100 over an undercut anchor and under a first portion 230 of a connecting structure on engaging element 50. In some exemplary embodiments, lateral forces applied on engaging element 50 may be partially spread over a surface area of load dispersion element 300. According to some exemplary embodiments, load bearing element 300 is a pressure relieving washer including a central bore 303. According to some exemplary embodiments, a nut element 262 is fitted in the central bore. In some exemplary embodiments, central bore 303 has a polygon shape, e.g., pentagonal for receiving nut element 262 and resisting rotation between nut element 262 in bore 303. Load dispersion element 300 is shown to have a pentagonal shape. Other shapes, e.g., rectangular, round, and hexagonal are also contemplated. In some exemplary embodiments, flaring element 260 may penetrate nut element 262 with a threaded engagement. The threaded engagement reinforce the pressure of the load dispersion element 300 against back surface 101 of end cladding element 100.

According to some exemplary embodiments, load dispersion element 300 is metal. In some exemplary embodiments, load dispersion element 300 has a width or diameter of 20 mm-70 mm, e.g., 40 mm and a bore with a diameter that is 5 mm-20 mm, e.g., 10 mm.

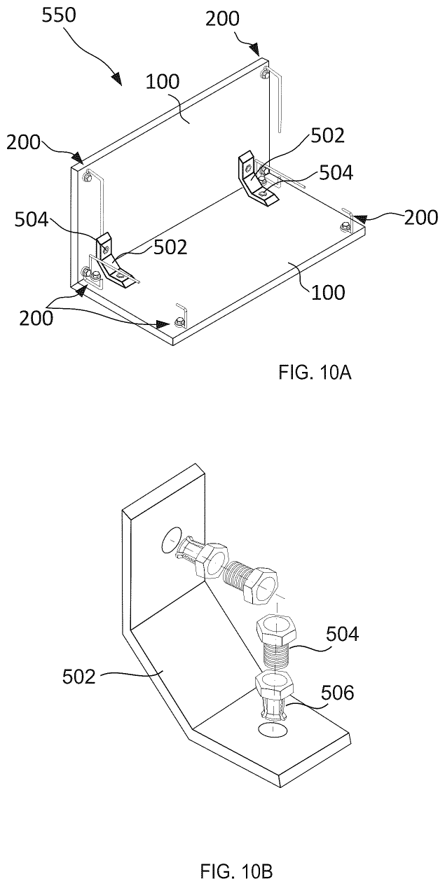

FIGS. 10A-B provide examples of assembled corner system in accordance with some exemplary embodiments. According to some exemplary embodiments, a system 550 for cladding a corner of a structure includes a pair of end cladding elements 100 attached to one another at a predetermined angle (e.g. right angles, closed angle or open angle) and secured from behind with one or more corner brackets 502. The corner structure may be the corner of building or another corner on the surface of the building—e.g. under a window, balcony, shelf etc. The corner of system 550 may be a Gerung type corner or a non-Gerung type corner. Preferably the corner structure comprises a sealant between the two end cladding elements. In some exemplary embodiments, end cladding elements 100 are formed with dedicated undercut holes configured for receiving an undercut anchor 506 and a flaring element 504 to flare the undercut anchor for fixing corner brackets 502 against end cladding elements 100. End cladding elements 100 may be additionally assembled with kits 200.

Thus, a kit for connecting to one another a first end cladding element to a second end cladding element at a predetermined angle is provided. The first end cladding element formed with a first undercut hole in a back surface thereof, the second end cladding element formed with a second undercut hole in a back surface thereof. The kit comprises a corner bracket having a first arm having a first hole formed there through and a second arm having a second hole formed there through, the first arm and the second arm connected to one another directly or indirectly via a connector element at the predetermined angle. The corner bracket may be at least in part (e.g. at the connector element region) spaced from the back surfaces of the cladding elements so as to allow cementitious material to fill the space formed between the corner bracket and the cladding elements, thereby further securing the end cladding elements of the corner system to the corner of the structure.

The kit further comprises a first undercut anchor and a second undercut anchor. The kit further comprises a first flaring element and a second flaring element. The first flaring element designed insertable through the first hole for flaring the first undercut anchor within the first undercut hole. The second flaring element designed insertable through the second hole for flaring the second undercut anchor within the second undercut hole. The advantage of the kit depicted in FIG. 10A is that it allows for “Gerung” type corner which is not affordable by the prior art as is evident from FIG. 1C.

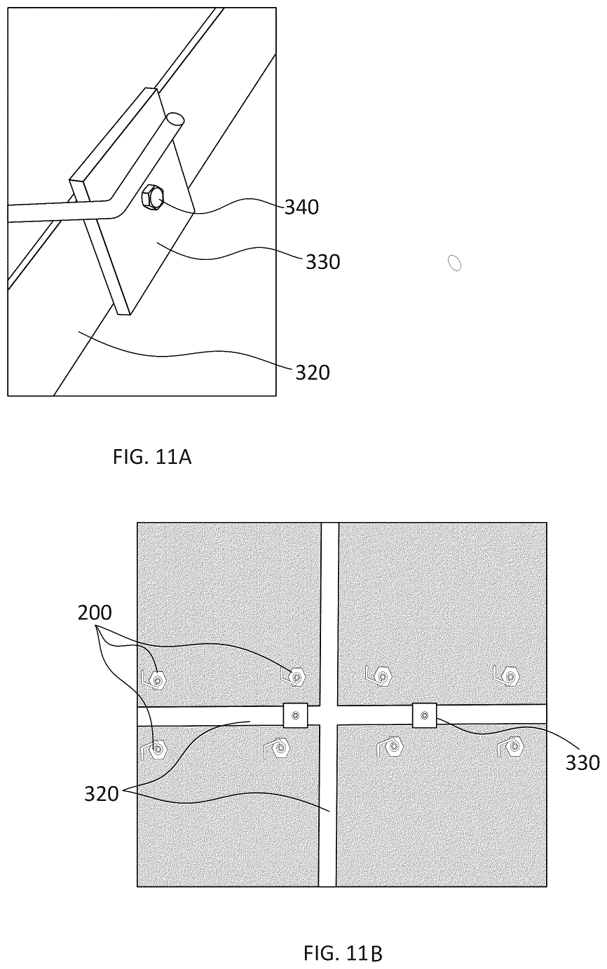

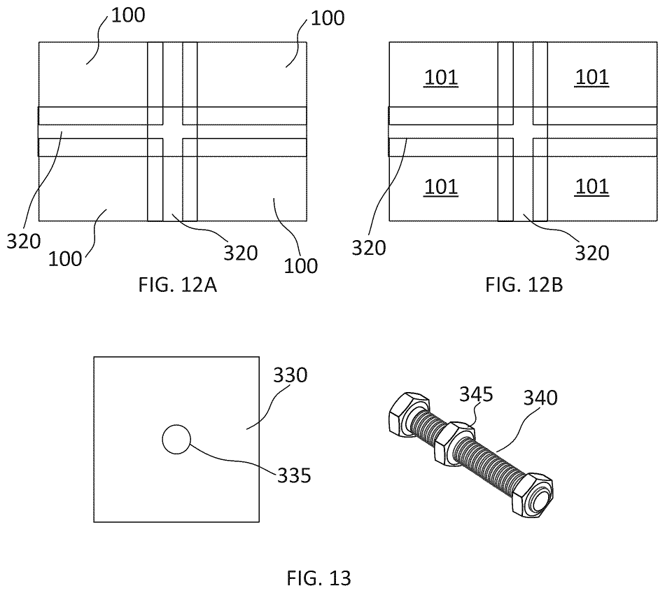

Reference is now made to FIGS. 11A and 11B showing different views of a securing plate assembly securing end cladding elements to an outer sheet of a formwork over gaps covered with a scaling strip, FIGS. 12A and 12B showing front and back views of four end cladding elements with sealing strips sealing gaps between the four end cladding elements and FIG. 13 showing an example securing plate assembly, all in accordance with some exemplary embodiments. According to some exemplary embodiments, sealing strips 320 are positioned over gaps between adjacent end cladding elements and are secured on back surfaces 101 of the end cladding elements. In some exemplary embodiments, scaling strips 320, provide a water impermeable seal to resist water penetrations through the gaps into the backup wall and resist leakage of cementitious material out to a front surface of the end cladding element during casting. According to some exemplary embodiments, sealing strips 320 are positioned over spacers of a formwork defining the spacing between end cladding elements. Scaling strips 320 may for example be a gasket. Since there are no pins penetrating the gaps between adjacent end cladding elements, it is possible to seal the gap with a solid material as opposed to a paste or liquid. The solid sealing may be more robust and may provide superior sealing. According to some exemplary embodiments, the sealing strip is a 1 mm Ethylene Propylene Diene Monomer (EPDM) sheet. EPDM sheets are known to be used to weather-seal roofs and are outdoor and UV rated for over 80 years of use. The sheet may be adhered to edges along back surface 101. According to some exemplary embodiments, substantially the entire surface area of back surface 101 is left exposed so that it can engage the cementitious material for chemical bonding.

According to some exemplary embodiments, securing plates 330 are configured to support back surfaces 101 of end cladding elements against formwork panel. Securing plates 330 supports the end cladding element over its edges so that back surfaces 101 can have substantially full contact with the cementitious material during casting. According to some exemplary embodiments, securing plates are rectangular plates with a bore 335 through which a securing element 340 is received. Securing element 340 may extend through an outer sheet of a formwork and may be fixed with a nut element 345 that engages securing element 340 with a threaded connection. According to some exemplary embodiments, the threaded connection resists leakage of cementitious material through bore 335 during casting and thereby provides a cleaner finish. In some exemplary embodiments, the securing plates 330 are used in place of the tying method used in the Baranovich system.

Securing plates 330 may be metal or may be another material that resists rust. According to some exemplary embodiments, securing plates 330 is formed with Delrin®. According to some exemplary embodiments, securing plates 330 are square with a width and height of 30 mm-90 mm, e.g., about 60 mm. According to some exemplary embodiments bore 335 is 5 mm 15 mm, e.g. 7 mm, in diameter.

After casting, securing element 340 is removed to release the outer sheet of formwork and expose the end cladding elements.

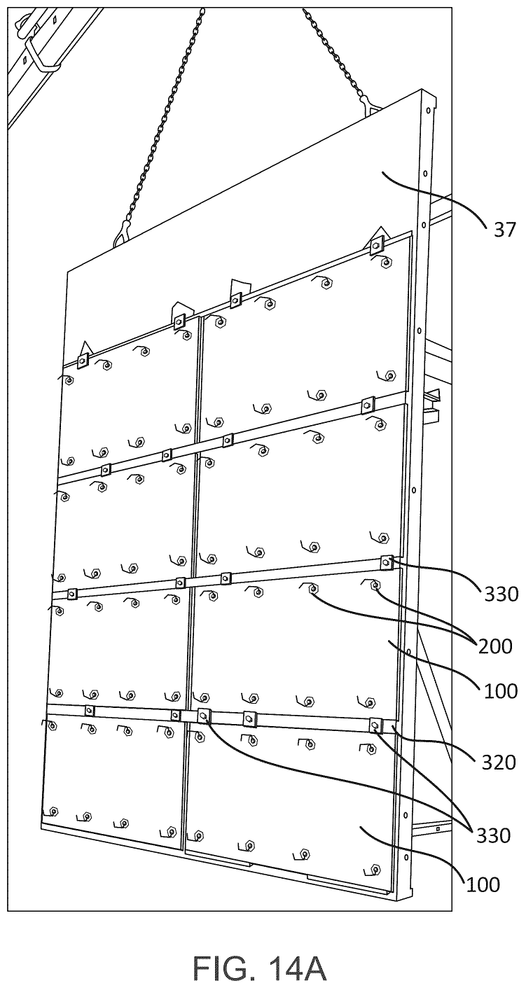

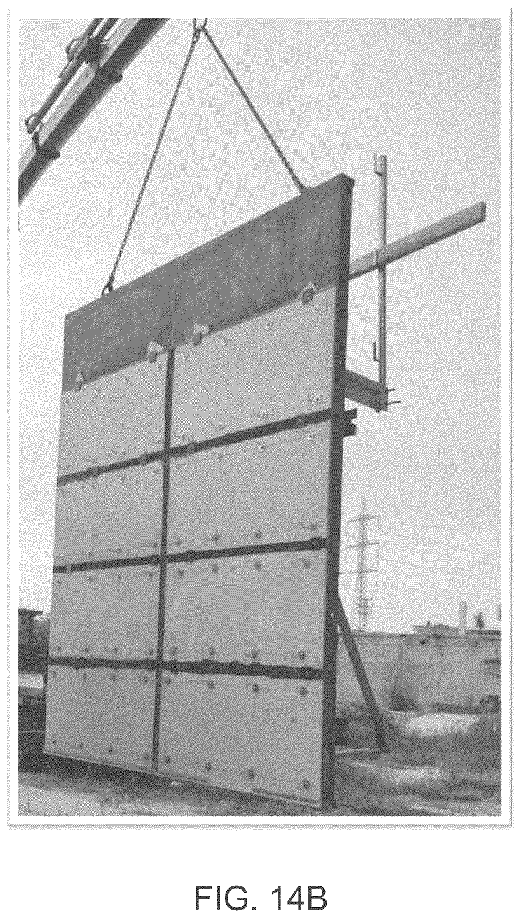

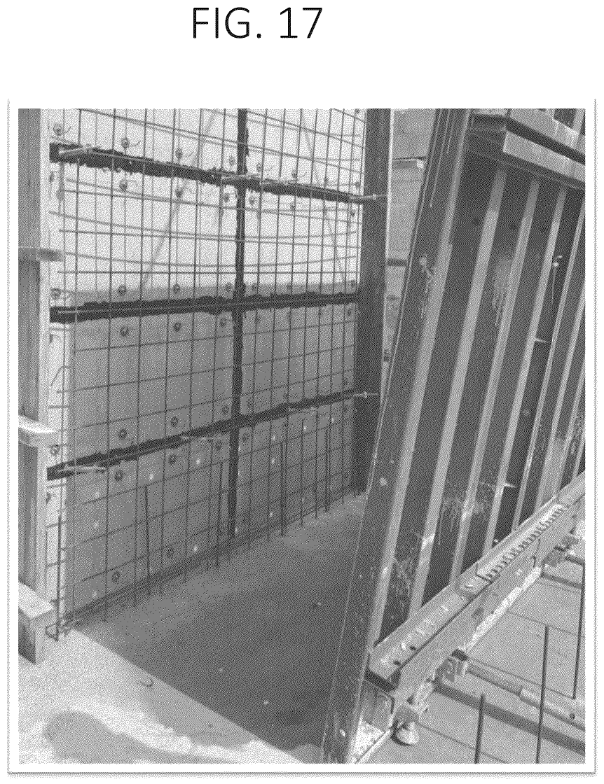

FIGS. 14A and 14B are a scheme and a photograph of an example outer sheet of a formwork including end cladding elements in according with some exemplary embodiments. According to some exemplary embodiments, an outer sheet 37 of a formwork is configured to support a plurality of end cladding elements 100. In some exemplary embodiments, end cladding elements 100 are assembled with kits 200. Gaps between end cladding elements 100 are sealed with scaling strip 320. According to some exemplary embodiments, end cladding elements 100 are held against outer sheet 37 formwork with securing plates 330 pressing against back surfaces of end cladding elements and bolted to outer sheet 37 through scaling strip 320. A photograph of an exemplary inner sheet of a formwork with the end cladding elements on the outer sheet is provided in FIG. 17.

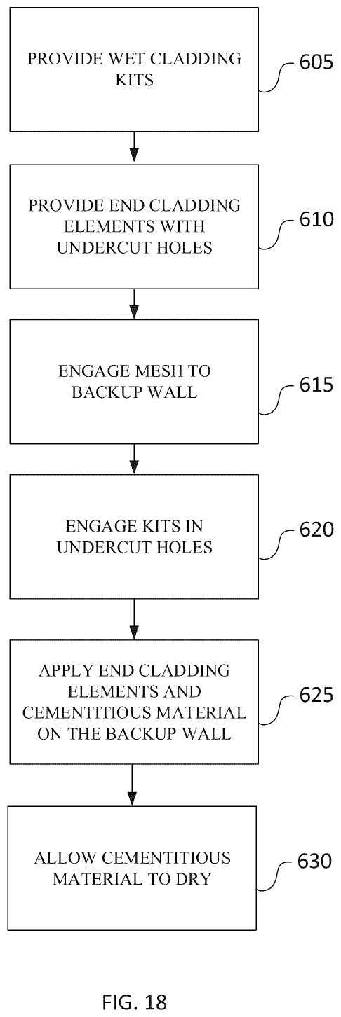

FIG. 18 is a simplified flow chart of an example method for wet cladding in accordance with some exemplary embodiments. According to some exemplary embodiments, the method includes providing both a plurality of wet cladding kits (block 605) and end cladding elements with hole (e.g. undercut holes) (block 610) at a construction site. According to some exemplary embodiments, one or more holes (e.g. undercut holes) may be formed in the end cladding elements as needed after receiving the system. In some exemplary embodiments, kits in the system may be fully or partially assembled on the end cladding if not already assembled when received. The assembled system may then be used to wet clad a precast backup wall of a structure. Wet cladding with the assembled system may for example be based on Israeli building standard 2378 method or based on the Baranovich method. In some exemplary embodiments, a reinforcement metal mesh is engaged to a backup wall (block 615). According to exemplary embodiments, the kits may then be engaged in the holes (e.g. undercut holes (block 620). The end cladding elements and the cementitious material are applied on the backup wall (block 625). According to some exemplary embodiments, the end cladding elements are spaced with spacers. The cementitious material may then be applied on the reinforcement metal mesh, on the backup wall, and/or on the back surface of the end cladding elements. According to some exemplary embodiments, the engaging elements penetrate holes of the reinforcement metal mesh and engage with the reinforcement metal mesh. The end cladding elements which are pressed against the cementitious material may then be allowed to dry (block 630). According to some exemplary embodiments, prior to allowing the cementitious material to dry, cementitious material leakages from a front surface of the end cladding elements is removed.

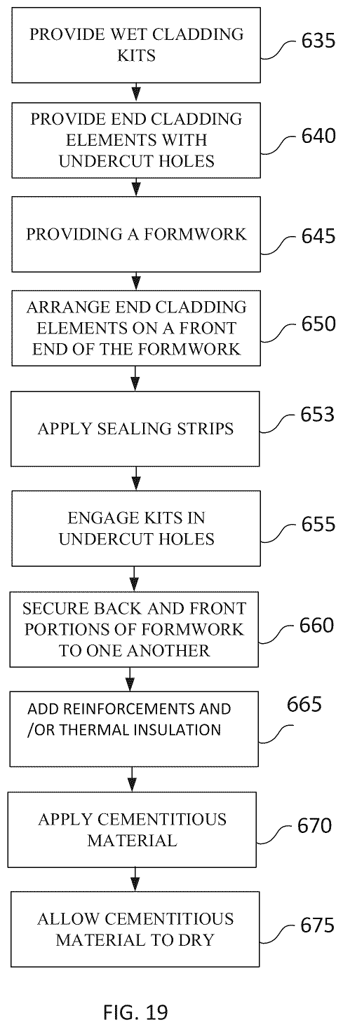

FIG. 19 is a simplified flow chart of an example method for wet cladding with formwork system in accordance with some exemplary embodiments. The method may be used to construct a cladded backup wall of a structure. According to some exemplary embodiments, the method includes providing both a plurality of wet cladding kits (block 635) and end cladding elements with holes (e.g. undercut holes (block 640) at a construction site. According to some exemplary embodiments, one or more holes (e.g. undercut holes) may be formed in the end cladding elements as needed after receiving the system. In some exemplary embodiments, kits in the system may be fully or partially assembled on the end cladding if not already assembled when received. The assembled system may then be used to wet clad a backup wall of a structure. Wet cladding with the assembled system may for example be based on the Baranovich method. The method may further include providing a formwork (block 645). In some exemplary embodiments, the formwork includes an outer sheet on which a front side of the end cladding elements is positioned and an inner sheet. The end cladding elements may be arranged on the front surface of the outer sheet of the formwork (block 650). According to some exemplary embodiments, the method includes spacing the end cladding elements with spacers positioned on said outer sheet of said formwork. According to some exemplary embodiments, the end cladding elements are secured against the outer sheet of said formwork with securing plates. According to some exemplary embodiments, the securing plates are secured to the outer sheet of said formwork through the spacers. According to some exemplary embodiments each of the securing plates are arranged on the back surface of the end cladding elements (over the joining edge of two adjacent end cladding elements with spacers therebetween). According to some exemplary embodiments, the spacers are fixed to the outer sheet of the formwork with a screw thread connection. In some exemplary embodiments, water scaling strips are applied onto back surfaces of the end cladding elements to cover gaps between the end cladding elements (block 653). The scaling strips may seal the gaps and prevent leakage of the cementitious material onto the front surface of the end cladding elements and the outer sheet of the formwork. According to some exemplary embodiments, the securing plates are positioned over the scaling strips.

According to exemplary embodiments, the kits may then be engaged in the holes (e.g., undercut holes) (block 655). According to some exemplary embodiments, one or more holes (e.g., undercut holes) may be formed in the end cladding elements as needed after receiving the system. In some exemplary embodiments, kits in the system may be fully or partially assembled on the end cladding if not already assembled when received. The assembled system may then be used to wet clad a backup wall of a structure. In some exemplary embodiments, a reinforcement metal mesh is placed between the end cladding elements and the inner sheet of the formwork, (wherein the cementitious material engaging elements optionally but not necessarily penetrate holes of the reinforcement metal mesh and engage with the reinforcement metal mesh). The front portion and the back portion of the formwork may then be secured to one another to define a volume in which the cementitious material may be received (block 660). Reinforcements may be added to the defined volume, e.g., reinforcement bars (block 665). According to some exemplary embodiments, a thermal insulating material may be added to the defined volume. According to some exemplary embodiments, the cementitious material is added to the defined volume (block 670) and allowed to dry (block 675). In some exemplary embodiments, the cementitious material is added with a pump pumping the cementitious material. In some exemplary embodiments, the cementitious material is added through a funnel to reduce the flow rate of the cementitious material within the volume. According to some exemplary embodiments, the cementitious material is added directly on the back surfaces of the end cladding material.

As mentioned, the present invention further contemplates constructing walls which are cladded both on the exterior facing surface of the wall and the interior facing surface of the wall.

In one embodiment, the exterior facing surface of the wall is clad using the kits described herein (e.g. kit 200). In another embodiment, the interior facing surface of the wall is clad using the kits described herein (e.g. kit 200). In still another embodiment, both the interior and the exterior of the wall are clad using the kits described herein. Alternatively, either one of the interior or the exterior facing surface is clad using other methods known in the art including for example the Baranovich method (further described herein above and illustrated in FIG. 1) or using U-shaped elements as further described herein below.

According to this embodiment, end cladding elements (with holes in either the back surface thereof or on the side thereof) suitable for cladding an interior facing surface are arranged on the front surface of an inner sheet of the formwork. According to some exemplary embodiments, the end cladding elements are not spaced with spacers on the formwork. According to some exemplary embodiments, the end cladding elements are secured against the inner sheet of the formwork with securing plates (as described herein above). According to some exemplary embodiments, the securing plates are fixed to the inner sheet of the formwork with a screw thread connection. Kits may then be engaged in the holes (e.g., undercut holes or uniform holes), as further described herein above.

After drying of the cementitious material, the inner sheet and outer sheet of the formwork may be removed. According to some exemplary embodiments, the method includes removing cementitious material leakages from a front surface of said plurality of end cladding elements.

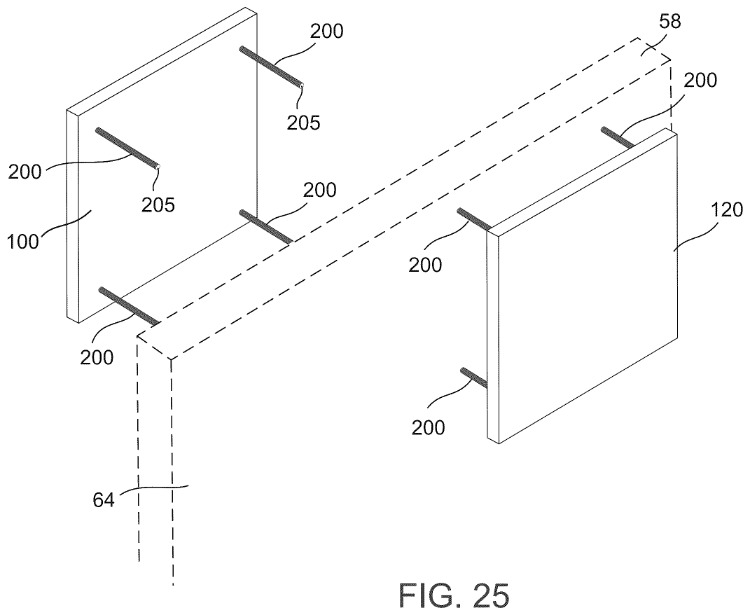

FIG. 25 is a diagram of a wall 58 which is cladded on both its interior facing surface 64 and the exterior facing surface. End-cladding element 100 suitable for cladding an exterior facing surface of the wall 58 is attached to the wall using kit 200, whereas end-cladding element 120 suitable for cladding an interior facing surface of the wall 58 is attached to the wall using kit 200.

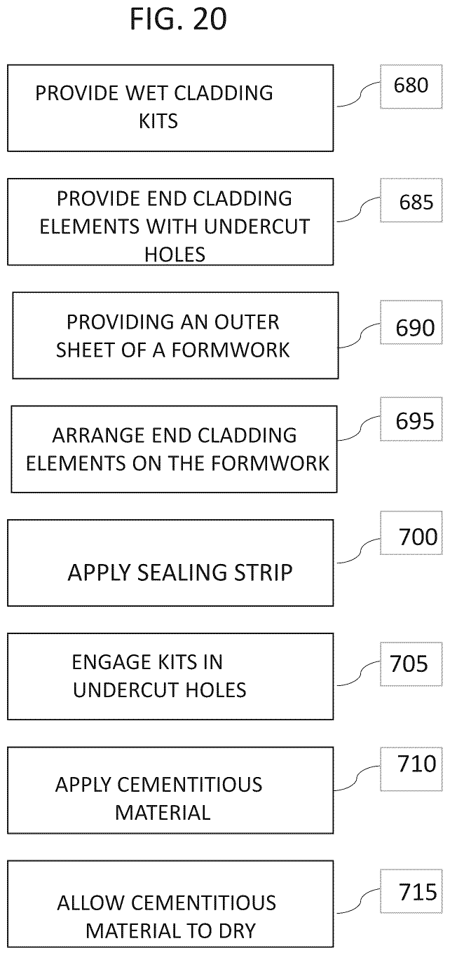

FIG. 20 is a simplified flow chart of an example method for wet cladding in accordance with some exemplary embodiments and is essentially similar to the one described in FIG. 19 except that the casting may be carried out on the ground (i.e. horizontally) without the need for both sides of a formwork. The method may be used to construct a cladded backup wall of a structure. According to some exemplary embodiments, the method includes providing both a plurality of wet cladding kits (block 680) and end cladding elements with holes (e.g., undercut holes) (block 685) at a construction site. According to some exemplary embodiments, one or more holes (e.g., undercut holes) may be formed on the back surface of the end cladding elements as needed after receiving the system. In some exemplary embodiments, kits in the system may be fully or partially assembled on the end cladding if not already assembled when received. The assembled system may then be used to construct a wet-cladded backup wall of a structure. The method may further include providing a framework which defines an enclosed space (block 690). In one embodiment, the framework comprises an outer sheet of a formwork. The end cladding elements may be arranged inside the area defined by the framework (block 695), optionally on a platform which comprises spacers, with the back surface of the end cladding element facing upwards. In some exemplary embodiments, water scaling strips are applied onto back surfaces of the end cladding elements to cover gaps between the end cladding elements (block 700). The sealing strips may seal the gaps and prevent leakage of the cementitious material onto the front surface of the end cladding elements and the outer sheet of the formwork. According to some exemplary embodiments, the securing plates are positioned over the sealing strips.

According to exemplary embodiments, the kits may then be engaged in the holes (e.g., undercut holes) (block 705). According to some exemplary embodiments, one or more hole (e.g., undercut holes) may be formed in the end cladding elements as needed after receiving the system. In some exemplary embodiments, kits in the system may be fully or partially assembled on the end cladding if not already assembled when received. In some exemplary embodiments, a reinforcement metal mesh is placed on top of the end cladding elements, (wherein the cementitious material engaging elements optionally but no obligatorily penetrate holes of the reinforcement metal mesh and engage with the reinforcement metal mesh). The assembled system may then be used to construct a cladded wall of a structure. According to some exemplary embodiments, the cementitious material is added to a volume defined by the framework (block 710) and allowed to dry (block 715). According to some exemplary embodiments, the cementitious material is added directly on the back surfaces of the end cladding material.

After drying of the cementitious material, the framework may be removed and the constructed wall may be moved to its appropriate location. According to some exemplary embodiments, the method includes removing cementitious material leakages from a front surface of said plurality of end cladding elements.

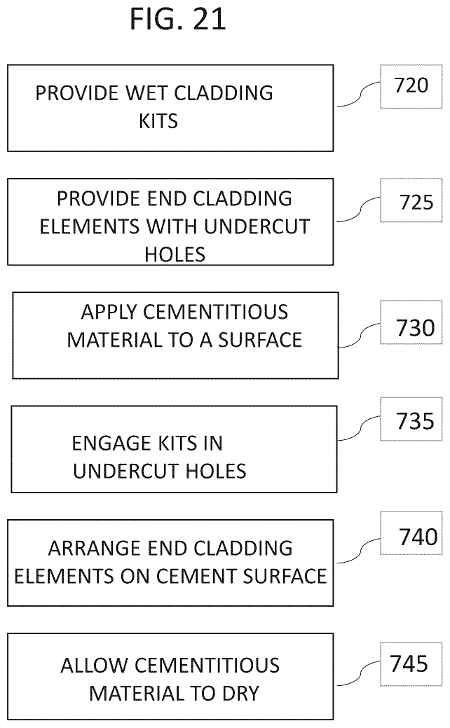

FIG. 21 is a simplified flow chart of an example method for wet cladding without a formwork system in accordance with some exemplary embodiments and is essentially similar to the one described in FIG. 20 except that the casting of the wall is carried out prior to placing of the end cladding elements. The method may be particularly suitable for constructing a cladded pre-cast wall. According to some exemplary embodiments, the method includes providing both a plurality of wet cladding kits (block 720) and end cladding elements with holes (e.g., undercut holes) (block 725) at a construction site. According to some exemplary embodiments, one or more holes (e.g., undercut holes) may be formed in the end cladding elements as needed after receiving the system. In some exemplary embodiments, kits in the system may be fully or partially assembled on the end cladding if not already assembled when received. The assembled system may then be used to construct a cladded wall. Cementitious material is spread on a horizontal surface—e.g., a floor (block 730) whose area has been defined using a framework. According to exemplary embodiments, the kits may then be engaged in the holes (e.g., undercut holes) (block 735). According to some exemplary embodiments, one or more holes (e.g., undercut holes) may be formed in the end cladding elements as needed after receiving the system. In some exemplary embodiments, kits in the system may be fully or partially assembled on the end cladding if not already assembled when received. The assembled system may then be used to wet clad a surface (e.g., a floor or a precast wall). The end cladding elements may be arranged on the surface to which the cementitious material has been applied (block 740). According to some exemplary embodiments, the method includes spacing the end cladding elements with spacers positioned on the surface. According to some exemplary embodiments, the cementitious material is added directly on the back surfaces of the end cladding material.

After drying of the cementitious material, leakages from a front surface of said plurality of end cladding elements may be removed.

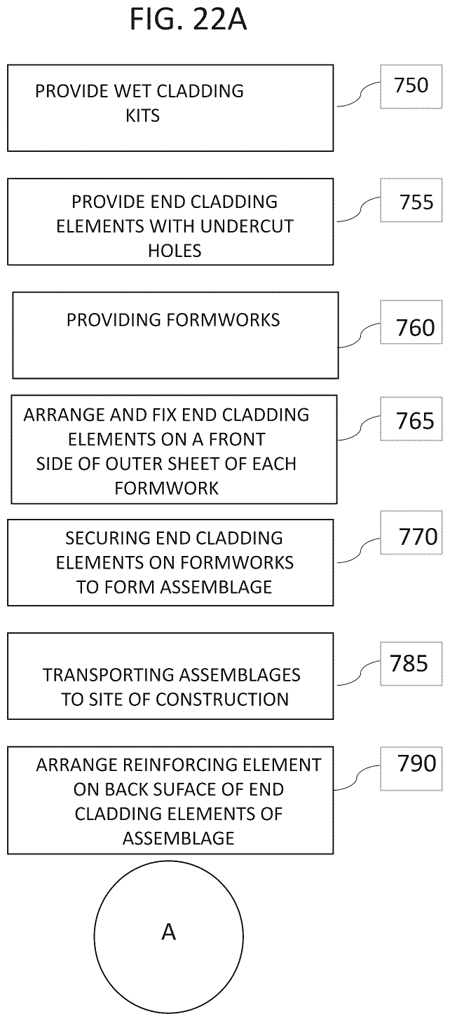

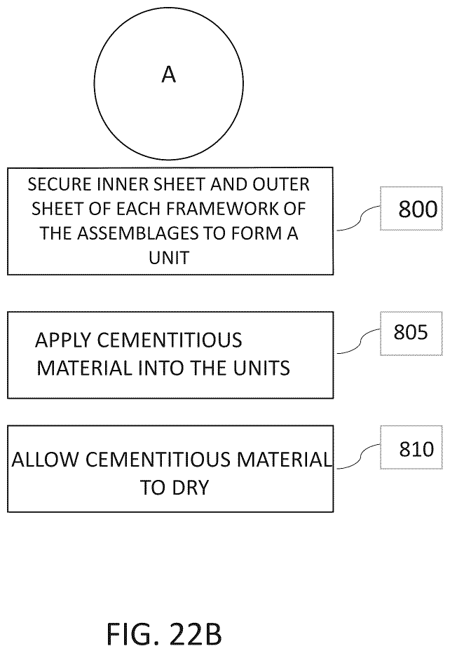

FIGS. 22A-B is a simplified flow chart of an example method for constructing a wet cladded structure with formwork system in accordance with some exemplary embodiments. According to some exemplary embodiments, the method includes providing both a plurality of wet cladding kits (block 750) and end cladding elements with holes (e.g., undercut holes) (block 755) at a construction site. According to some exemplary embodiments, one or more holes (e.g., undercut holes) may be formed in the end cladding elements as needed after receiving the system. In some exemplary embodiments, kits in the system may be fully or partially assembled on the end cladding if not already assembled when received. Wet cladding with the assembled system may for example be based on the Baranovich method. The method may further include providing a plurality of formworks (block 760). In some exemplary embodiments, the formwork includes an outer sheet on which a front side of the end cladding elements is positioned and an inner sheet. The end cladding elements may be arranged and secured on the front surface of each of the formworks (block 765), as described herein above so as to form a plurality of assemblages. According to some exemplary embodiments, the method includes spacing the end cladding elements with spacers positioned on said outer sheet of said formwork. According to some exemplary embodiments, the end cladding elements are secured against the outer sheet of said formwork with securing plates. According to some exemplary embodiments, the securing plates are secured to the outer sheet of said formwork through the spacers. According to some exemplary embodiments each of the securing plates are arranged on the back surface of the end cladding elements (over the joining edge of two adjacent end cladding elements with spacers therebetween). According to some exemplary embodiments, the spacers are fixed to the outer sheet of the formwork with a screw thread connection. In some exemplary embodiments, water sealing strips are applied onto back surfaces of the end cladding elements to cover gaps between the end cladding elements. The sealing strips may seal the gaps and prevent leakage of the cementitious material onto the front surface of the end cladding elements and the outer sheet of the formwork. According to some exemplary embodiments, the securing plates are positioned over the scaling strips.

If not already at the site of construction, the assemblages are then hoisted to a floor under construction and placed adjacent to one another to form a continuous structure of assemblages (block 785).

In some exemplary embodiments, a reinforcement metal mesh is placed between the end cladding elements and the inner sheet of the formwork-block 790.

According to some exemplary embodiments, a thermal insulating material may be added to the defined volume.

The front portion and the back portion of the formwork may then be secured to one another to define a volume in which the cementitious material may be received and form an assemblage (block 800). A continuous framework unit is thus constructed. Cementitious material is added into the continuous framework unit (block 805) and allowed to dry (block 810). In some exemplary embodiments, the cementitious material is added with a pump pumping the cementitious material. In some exemplary embodiments, the cementitious material is added through a funnel to reduce the flow rate of the cementitious material within the volume.

Table 2 below combines some optional engineering values, rendering the wet cladding kits, methods, systems and/or constructions of some exemplary embodiments superior over any prior art wet cladding method. It is to be understood that any optional value or any combination of any one or more optional alternative values can be used in conjunction of the wet cladding kits, methods, systems and/or constructions described herein, even if a given combination of any one or more optional alternative values is not explicitly described.

TABLE 2

| Item | Specification |
|---|---|
| Material | e.g., Ceramic Porcelain, other |
| Size | X: at least 35 cm; |
| | Y: at least 35 cm; |
| | Alternatively and optionally |
| | 30 × 60-60 × 120 cm². |
| Inherent water absorption | Less than 0.5% w/w when soaked |
| | in water. E.g., less than 0.1% w/w. |
| | Optionally, 0% w/w. |
| | Substantially o water absorption |
| | from the front surface of the |
| | cladding element. |
| Abrasion Resistance | Class, 1 or better, Class 2 or better, |
| | class 3 or better, Class 4 or better, |
| | According to Israeli Building |
| | Standard 314. |
| Tile Thickness | 9-12 mm, optionally about 10 mm. |
| Tile Breaking Strength | Over 1300 Newton, optionally over |
| | 1600 Newton, optionally over 2000 |
| | Newton |
| Tile Bending Strength | 32 Newton/mm², optionally 35 |
| | Newton/mm² |
| Tile Breaking strength | At least 1300 Newton, optionally at |
| | least 1550 Newton, optionally at |
| | least 1,800 Newton |

Mechanical Fixing of the Kit to the end cladding element

| | |
|---|---|
| Kit pull strength | Over 10 Kg pull strength, |
| | optionally over 20 Kg pull strength, |
| | optionally over 40 Kg pull strength |
| | optionally about 10 Kg pull |
| | strength. |
| Pin thickness (per kit) | At least 3 mm, optionally at least |
| | about 4 mm. |
| Pin Material | Stainless steel (Nirosta), optionally |
| | stainless steel 316, optionally |
| | stainless steel 304 |
| Load Dispersion Element (per kit) | At least 20 mm in diameter, |
| | optionally at least 30 mm in |
| | diameter, optionally at least 40 mm |
| | in diameter, optionally at least 50 |
| | mm in diameter. If not circular, |
| | diameter refers to the longest |
| | diameter of an inclusion circle. |
| | Optionally 0.5-2 mm in thickness, |
| | optionally about 1 mm in thickness. |
| Pin Length (per kit), | 50-90 mm, optionally 50-80. |
| protrusion into | |
| cement/concrete | |
| Undercut Hole Diameter at surface | 5-9 mm, optionally about 6 mm. |
| Undercut Hole Depth | 5-7 mm, optionally about 6 mm. |
| Chemical Bonding Pull Strength | At least 1 MPs/mm², optionally at |
| | least 1.5 MPs/mm², optionally at |
| | least 2 MPs/mm². (average of at |
| | least 10 measurements) |
| Cladding element pulling strength | At least 100 Kg/m², optionally at |
| | least 500 Kg/m², optionally at least |
| | 1000 Kg/m², optionally at least |
| | 1500 Kg/m², optionally at least |
| | 2000 Kg/m², optionally at least |
| | 2300 Kg/m². |
| Kits per square meter of cladding | At least 11, at least 12; at least 13- |
| element | 20. |
| Kits per Kg of cladding element | At least 11/35 Kg, at least 12/35 |
| | Kg; at least 13-20/35K. |

The present inventors have now devised a method for attaching an undercut anchor to the back surface of an end-cladding element without the need to drill an undercut hole, provided the material of the end-cladding element is sufficiently non-brittle and plastic.

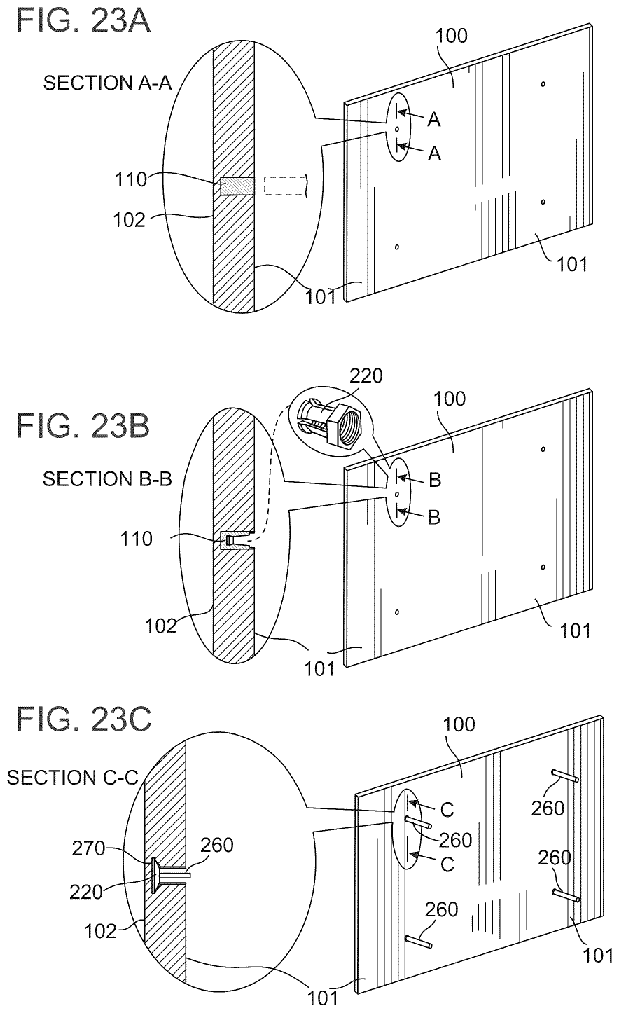

FIGS. 23A-C illustrate how an undercut anchor may be attached to an end-cladding element without the need to drill undercut holes.

FIG. 23A depicts a round, blind hole 110 having an opening on a back surface 101 of an end-cladding element 100. Blind hole 110 is defined by internal walls having a length and a substantially identical diameter along the length. Blind hole 110 does not penetrate the front surface 102 of the end-cladding element 100.

FIG. 23B depicts an unflared undercut anchor 220 partially inserted into a blind hole 110.

FIG. 23C depicts a flared undercut anchor 220 which has now been fully inserted into blind hole 110, following the screwing of a flaring element 260 into undercut anchor 220. The screwing allows undercut anchor 220 to flare inside hole 110 beyond the internal walls of the hole. As the anchor flares, it compresses material of the end-cladding element defining the hole. Thus, the material 270 of the end-cladding element surrounding undercut anchor 220 is more compressed than the material of the end-cladding element not surrounding the undercut anchor. Without being bound to theory, it is believed that the compression of the material around the undercut anchor leads to the enhanced retention force exerted by the end-cladding element on the undercut anchor.

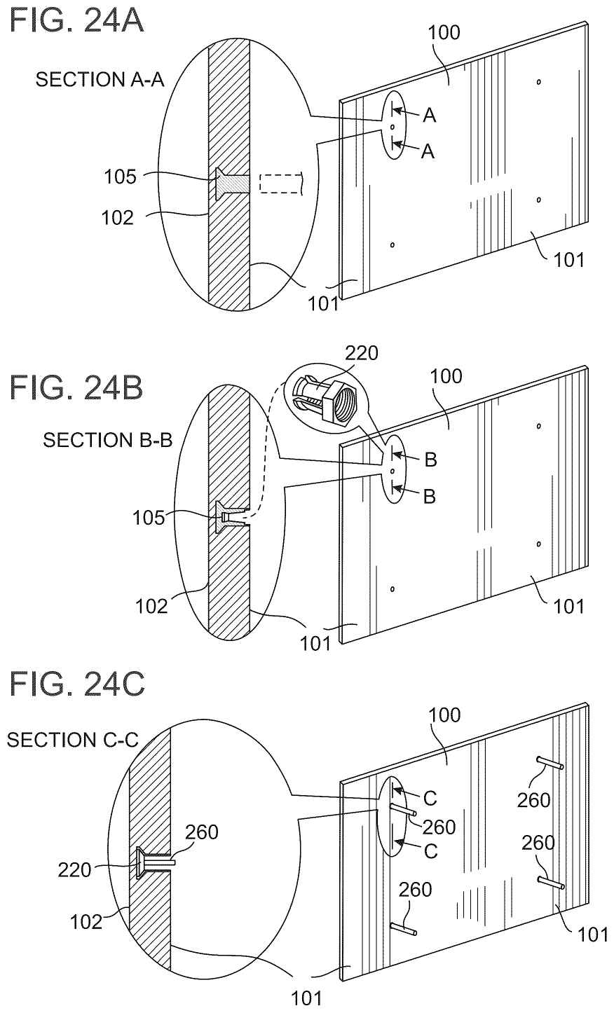

For the sake of comparison, reference is now made to FIGS. 24A-24C which depicts various stages of securing an undercut anchor in an undercut hole which traverses a thickness of an end-cladding element, according to currently known methods.

FIG. 24A depicts undercut hole 105 on a back surface 101 of end-cladding element 100.

FIG. 24B depicts a non-flared undercut anchor 220 partially inserted into undercut hole 105.

FIG. 24C depicts flared undercut anchor 220 which has now been fully inserted into undercut hole 105, following the screwing of flaring element 260 into undercut anchor 220. The screwing allows the undercut anchor to flare inside the hole.

The present method for securing an undercut anchor into an end-cladding element portrayed in FIGS. 23A-C may be summarized as follows:

A method of securing an undercut anchor in a blind hole which traverses a thickness of an end-cladding element, the blind hole having an opening on a back surface of the end-cladding element, the blind hole being defined by internal walls having a length and a substantially identical diameter along said length, the method comprises inserting the undercut anchor into the blind hole; and screwing a flaring element into the undercut anchor, so as to allow the undercut anchor to flare inside the hole and beyond the internal walls of the hole, while compressing material of the end-cladding element surrounding the hole.

According to some exemplary embodiments, the end-cladding elements may be pre-formed with the uniform holes, e.g., during manufacturing or may be drilled following manufacturing. In an exemplary embodiment, the hole is about 5-7 mm in diameter and about 4-7 mm in depth. According to exemplary embodiments, the end-cladding element is formed with a plurality of holes, e.g., 4-8, 4-12 or 4-50 holes.

Typically, each end-cladding element comprises a plurality of holes—for example at least four, one in each corner, at least 6, at least 8, at least 12. Depending on the size of the end-cladding element more holes may be drilled.

Thus, the present invention provides for an end-cladding element having a back surface which comprises a blind hole into which an undercut anchor has been flared and secured, the end-cladding element being fabricated from a material, wherein the material of the end-cladding element surrounding the undercut anchor, after the undercut anchor has been flared and secured, is more compressed than the material of the end-cladding element not surrounding the undercut anchor.

The end-cladding elements which can be used in the present invention have a wide range of thicknesses less than 3 cm, e.g., 1 cm-3 cm, less than 2 cm, e.g., 1.9 cm, or 1.5 cm or less, or even 9-12 mm. The end-cladding elements may be of any shape (e.g., a polygon, such as rectangular or square; or combination of polygons having, for example, 5 and 6 gons to clad curved surfaces; or a non-polygon) and of any size—e.g., between 20 cm-5 meters in length and between 20 cm to 5 meters in height. According to some exemplary embodiments at least one of the plurality of cladding elements is a quadrangle having X and Y dimensions, whereby both X and Y are each independently greater than 35 cm. The back surface of the end-cladding element may be smooth or rough.

The end-cladding element is fabricated from a material having a plasticity and being sufficiently non-brittle, so as to allow flaring of the undercut anchor into the material without breaking the end-cladding element, the material having a retention force that allows rigid attachment of the undercut anchor to the end-cladding element.

According to a particular embodiment, the end-cladding element is fabricated from a cementitious material, including but not limited to pre-fabricated cement boards (e.g., cement bonded particle board or a cement fiber board).

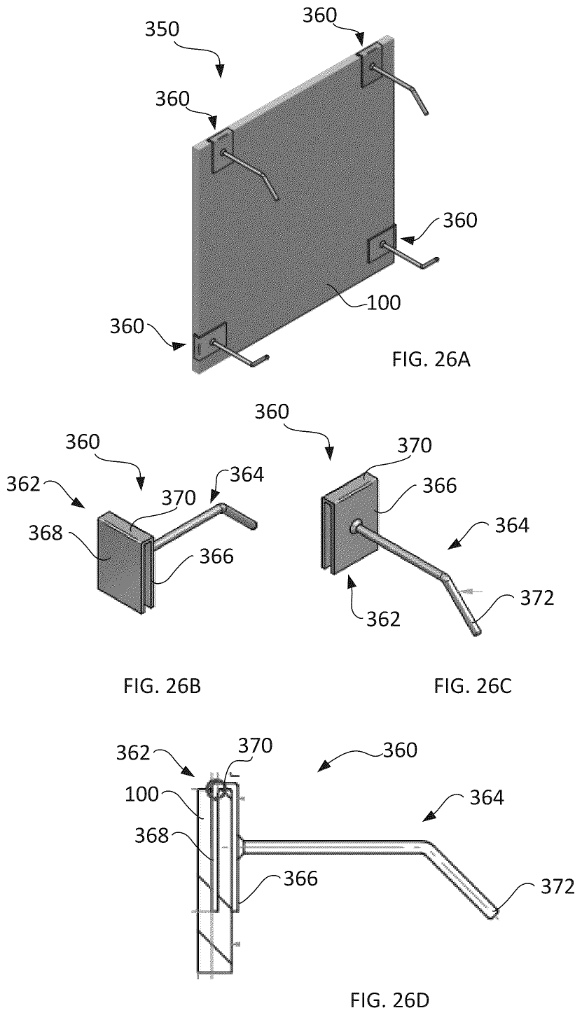

As mentioned herein above, the present invention also contemplates using U-shaped elements for connecting cementitious material engaging elements to end-cladding elements via holes (e.g. slots) in the sides of the end-cladding elements. The end-cladding elements must be sufficiently thick and non-brittle so as to allow drilling of side holes therein. This method will be further described with the aid of FIGS. 26A-D, 27A-C and 28A-B.

FIGS. 26A, 26B, 26C and 26D are respectively an alternate example system including an example kit with an example U-shaped element, two perspective views of the example kit and a sectional view of the example kit installed on an edge of an end cladding element, all in accordance with some example embodiments. According to some example embodiments, a system 350 includes an end cladding element 100 and one or more end cladding kits 360. According to some example embodiments, kit 360 includes a U-shaped element 362 and a pin 364 (i.e., a cementitious material engaging element) extending out from U-shaped element 362. U-shaped element is formed with a first wall 366, a second wall 368 spaced from first wall 366 and a base 370 extending from first wall 366 to second wall 368. According to some example embodiments, pin 364 extends out from first wall 366 in a substantially normal direction. A distal end of pin 364 may include cement anchoring element 372. According to some example embodiments, second wall 368 is configured to be received within a slot formed through an edge surface of end cladding element 100.

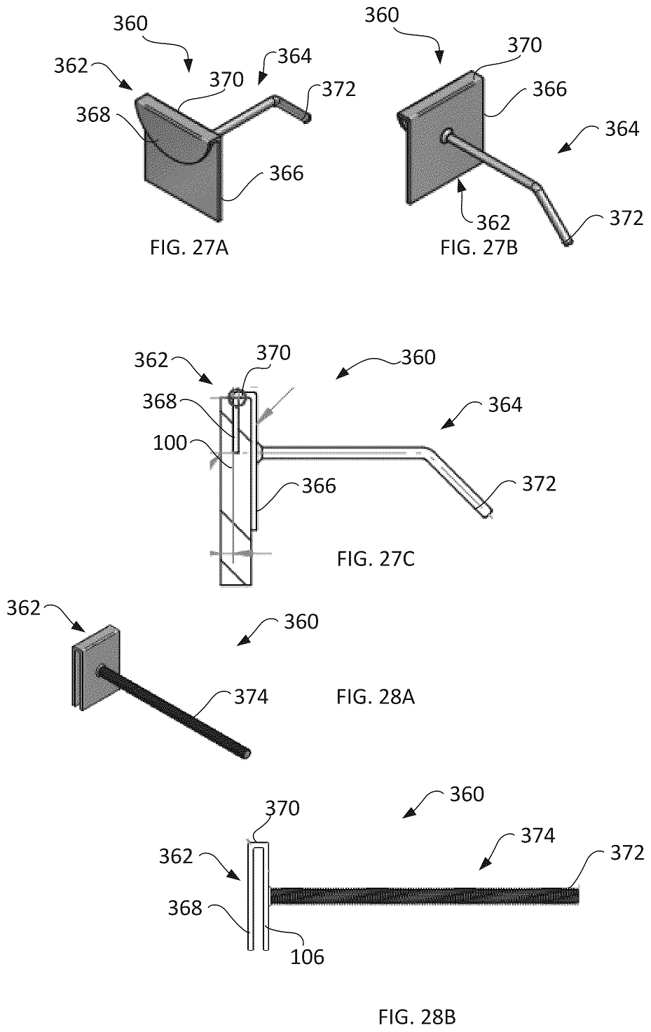

FIGS. 27A, 27B and 27C are two perspective views of another example kit with a U-shaped piece and a sectional view of the example kit installed on an edge of an end cladding element, all in accordance with some example embodiments. In some example embodiments, second wall 368 of U-shaped element 362 may be shorter than first wall 366 and/or otherwise shaped. Optionally, second wall 368 includes a curved shape to match a shape of a slot cut through an edge surface of end cladding element through which second wall 368 is to be received.

FIGS. 28A and 28B are respectively a perspective view and a side view of yet another example kit including a U-shaped piece in accordance with some example embodiments. In some example embodiments, kit 360 includes a stud pin 374 with screw threads that extend to cement anchoring element 372 at a distal end. In other example embodiments, the screw threads do not extend into cement anchoring element 372. Stud pin 374 may be fixed onto U-shaped element 362 based on welding or with a screw type connection.

As used herein the term “about” refers to +10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, and mechanical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

In addition, any priority document(s) of this application is/are hereby incorporated herein by reference in its/their entirety.

1. A wet cladding kit for fixing an end cladding element to cementitious material of, or on, a backup wall, the kit comprising:
an undercut anchor configured for being inserted into a hole formed on a back surface of the end cladding element;
a flaring element configured for flaring said undercut anchor in said hole, said flaring element comprises a first portion of a connecting structure; and
a cementitious material engaging element which comprises at its proximal end a second portion of said connecting structure, said second portion of said connecting structure directly or indirectly connectable to said first portion of said connecting structure, said cementitious material engaging element further comprises a distal end extending from said second portion of said connecting structure for being embedded in the cementitious material;
wherein said first portion of said connecting structure and said second portion of said connecting structure are designed to be directly or indirectly potentially looseably connectable to form said connecting structure, so as to reduce a tendency of said undercut anchor from damaging walls defining said hole when a torque is applied onto said engaging element;
whereby said undercut anchor, said flaring element and said connecting structure are selected to provide a load bearing attachment between said cementitious material engaging element and the end cladding element, so as to provide mechanical fixing of the end cladding element to the cementitious material when the cementitious material is hardened.

2-3. (canceled)

4. The kit of claim 1, wherein said cementitious material engaging element has a normal vector component in said distal end which, during service, is positioned parallel to said backup wall and said end cladding element, wherein said normal vector component is formed, at least in part, by selecting said distal end of said cementitious material engaging element with a bend.

5-6. (canceled)

7. The kit of claim 1, further comprising a load dispersion element connectable to, or integrally formed with, said flaring element or said undercut anchor, wherein said load dispersion element is configured to disperse load over a surface area of said load dispersion element, said surface area being at least twice the surface area of said hole, so as to reduce load imposed by said undercut anchor on walls defining said hole.

8. The kit of claim 1, wherein said second portion of said connecting structure is a connecting element selected from the group consisting of a washer shaped element, a closed ring, an open ring, a loop and a helix.

9. The kit of claim 1, wherein said first portion of said connecting structure is a head structure of said flaring element.

10. The kit of claim 1, wherein said flaring element is a threaded element configured to be received through said second portion of said connecting structure and into said undercut anchor to fix said cementitious material engaging element onto said back surface of the end cladding element.

11-13. (canceled)

14. A wet cladding system for fixing an end cladding element to cementitious material of or on a backup wall comprising:
at least one kit according to claim 1; and
at least one end cladding element.

15. The wet cladding system of claim 14, wherein said hole is an undercut hole.

16. The wet cladding system of claim 14, wherein said hole is a blind hole which traverses a thickness of an end-cladding element, said blind hole having an opening on a back surface of said end-cladding element, said blind hole being defined by internal walls having a length and a substantially identical diameter along said length.

17. The wet cladding system of claim 16, wherein said material has a plasticity and is sufficiently non-brittle, so as to allow flaring of said undercut anchor into said material without breaking said end-cladding element, said material having a retention force that allows rigid attachment of said undercut anchor to said end-cladding element.

18. (canceled)

19. The wet cladding system of claim 16, wherein said end-cladding element is fabricated from a pre-prefabricated cementitious material.

20-31. (canceled)

32. The wet cladding system of claim 14, further comprising water sealing strips for sealing gaps between adjacent end cladding elements.

33. The wet cladding system of claim 14, further comprising securing plates and removable end cladding element securing agents for temporarily securing said end cladding elements to an outer sheet of said formwork.

34. (canceled)

35. A method of wet cladding a backup wall, the method comprising:
(a) providing a plurality of kits according to claim 1;
(b) providing a plurality of end cladding elements having back surfaces which comprise a hole;
(c) engaging a reinforcement metal mesh onto a backup wall to be cladded;
(d) engaging said kits in said undercut holes; and
(e) applying said cementitious material between said back surfaces of said plurality of end cladding elements and said backup wall with said cementitious material engaging elements penetrating into the cementitious material;
(f) allowing said cementitious material to harden with said cementitious material engaging elements penetrating therein, thereby providing mechanical fixing and chemical bonding of said plurality of end cladding elements to the cementitious material when said cementitious material is hardened, thereby wet cladding the backup wall.

36-40. (canceled)

41. A wet cladding method of constructing a cladded wall, the method comprising:
(a) providing a plurality of kits according to claim 1;
(b) providing a plurality of end cladding elements formed with holes in back surfaces of said plurality of end cladding elements;
(c) providing a formwork having an outer sheet and an inner sheet;
(d) arranging said plurality of end cladding elements with a front surface thereof against a back surface of said outer sheet of said formwork;
(e) engaging said plurality of kits in said undercut holes;
(f) securing said inner sheet and said outer sheet of said formwork to one another with formwork securing elements;
(g) applying said cementitious material into said formwork; and
(h) allowing said cementitious material to harden with said cementitious material engaging elements penetrating therein, thereby providing said mechanical fixing and chemical bonding of the end cladding elements to said cementitious material when the cementitious material is hardened, thereby constructing the cladded wall.

42-58. (canceled)

59. A wet cladding method for constructing a cladded wall, the method comprising:
(a) providing a plurality of kits according to claim 1;
(b) providing a plurality of end cladding elements formed with undercut holes on back surfaces of said plurality of end cladding elements;
(c) placing said plurality of end cladding elements inside an area defined by a horizontal framework;
(d) engaging said plurality of kits in said undercut holes;
(e) applying said cementitious material onto said back surfaces;
(f) allowing said cementitious material to harden with said cementitious material engaging elements of said kits penetrating therein, thereby providing mechanical fixing and chemical bonding of said plurality of end cladding elements to said cementitious material once hardened, thereby constructing the cladded wall.

60. (canceled)

61. A wet cladding method for constructing a cladded wall, the method comprising:
(a) providing a plurality of kits according to claim 1;
(b) providing a plurality of end cladding elements formed with undercut holes on back surfaces of said plurality of end cladding elements;
(c) applying cementitious material into a horizontal framework;
(d) engaging said plurality of kits in said undercut holes;
(e) placing said plurality of end cladding elements with a back surface thereof onto said cementitious material;
(f) allowing said cementitious material to harden with said cementitious material engaging elements of said kits penetrating therein, thereby providing mechanical fixing and chemical bonding of said plurality of end cladding elements to said cementitious material once hardened, thereby constructing the cladded wall.

62-63. (canceled)

64. A wet cladding method, the method comprising:
(a) providing a plurality of kits according to claim 1;
(b) providing a plurality of end cladding elements formed with holes in back surfaces of said plurality of end cladding elements;
(c) providing a plurality of formworks, each said formwork having an outer sheet and an inner sheet;
(d) placing said plurality of end cladding elements with a front surface thereof against a back surface of said outer sheet of each said formwork;
(e) engaging said plurality of kits in said holes;
(f) securing said plurality of end cladding elements to said outer sheet of each said formwork so as to form a plurality of assemblages;
(g) hoisting said plurality of assemblages to a floor under construction and placing said plurality of assemblages adjacent to one another;
(h) placing a plurality of reinforcing elements against said back surface of said plurality of end cladding elements;
(i) optionally placing heat insulating building blocks against said plurality of reinforcing elements;
j) securing each said inner sheet and each respective said outer sheet of said plurality of formworks to one another with formwork securing elements, so as to form a continuous formwork unit;
(k) applying said cementitious material into said continuous formwork unit;
(l) allowing said cementitious material to harden with said cementitious material engaging element penetrating therein, thereby providing said mechanical fixing and chemical bonding of the end cladding elements to said cementitious material once hardened.

65-83. (canceled)

84. A wet cladding method, the method comprising:
(a) attaching a plurality of cementitious material engaging elements to back surfaces of a plurality of cladding elements;
(b) arranging said plurality of cladding elements in a formwork;
(c) securing said plurality of end cladding elements with securing plates and removable end cladding element securing screw to said formwork; and
(d) adding cementitious material to the formwork, thereby providing mechanical fixing and chemical bonding of the end cladding elements to said cementitious material once hardened.

85-91. (canceled)

92. The method of claim 41, wherein said chemical bonding pull strength exceeds 1 MegaPascal (MPs) per mm².

93-108. (canceled)
